(19) United States
(12) Patent Application Publication
(10) Pub. No.: US 2006/0127278 A1
(43) Pub. Date: Jun. 15, 2006

(54) System and method of measuring molecular interactions

(76) Inventors: Alice P. Gast, Waban, MA (US); James T. Kellis JR., Palo Alto, CA (US); Joon-H Kim, Taejon (KR); Ayrookaran Poulose, Palo Alto, CA (US); Shaunak Roy, San Mateo, CA (US)

Correspondence Address: GENENCOR INTERNATIONAL, INC.;ATTENTION: LEGAL DEPARTMENT, 925 PAGE MILL ROAD, PALO ALTO, CA, 94304, US

(21) Appl. No.: 10/508,294

(22) PCT Filed: Apr. 25, 2003
(86) PCT No.: PCT/US03/12865

§ 371 Date: Oct. 11, 2005

Related U.S. Application Data
(60) Provisional application No. 60/376,215, filed on Apr. 26, 2002.

(51) Int. Cl. G01N 21/64

(52) U.S. Cl. 422/82.05; 435/287.2

(57) ABSTRACT

The present disclosure relates to a device for measuring surface plasmon resonance and fluorescence of a sample, a system for determining the rate of catalytic activity of an enzyme, a method of determining the rate of catalytic activity of an enzyme, and a method of measuring the adsorption and reactivity of a substance, all of which use SPR and SPEF methods simultaneously. This invention also relates generally to systems and methods for measuring diffusion and reactivity of macromolecules on a surface.

### BACKGROUND OF THE INVENTION

1. Field of the Invention

This invention relates generally to systems and methods for measuring molecular interactions. More specifically, the invention relates to measurements of surface adsorption and/or reactions using a combination of surface plasmon resonance and surface plasmon enhanced fluorescence detection. This invention also relates to systems and methods for measuring diffusion and reactivity of macromolecules on a surface.

2. Description of the Related Art

Surface Plasmon Resonance (SPR) is a physical process that occurs when light of a particular wavelength that has been plane polarized (p-polarized) interacts with a thin metal film at a specific angle of incidence. One way to couple light to a thin metal film is through a prism of glass or other optically transparent solid. Light directed through glass or another optically transparent solid such as quartz or plastic and impinging on an interface of the solid and dielectric, will partially reflect back out of the solid and otherwise refract into the dielectric at the point of impingement. When the angle of incidence of the incoming light achieves a critical angle all of the light will reflect back through the solid. This is known as total internal reflection (IIR), and even though no photons are passing beyond the surface of the solid, an electrical field from the photons, known as an evanescent wave, extends beyond the reflecting surface.

The thin film of metal used in SPR contains free electron constellations that are affected by electrical fields. When such a film is applied to the interface between a clear solid and a dielectric, the energy field of the photons causes excitation of these electron constellations resulting in the propagation of surface plasmons, or electron density waves. These waves propagate along the surface of the thin film. The propagation of the photon electrical field is dependent on the frequency and the angle of the incident light, as well as the refractive indices of the dielectrics on either side of the film.

When p-polarized light of the correct frequency strikes the surface at the appropriate angle under TIR, the energy of the photon energy field is transferred to the surface plasmons as resonance is achieved. Surface plasmon resonance occurs when the component of the light wave-vector matches the real component of the wave-vector of the surface plasmon. This resonance results in a sharp decrease in the energy of the reflected light as that energy is transferred to the plasmons.

As mentioned previously, the angle and energy at which resonance occurs is dependent on the refractive properties of the dielectrics on either side of the thin film. For a monochromatic light source, the angle of incidence at which resonance occurs will vary if the properties of the surface of the film change due to its altered refractive index. Similarly, if a sample to be measured is layered on the thin film, the dielectric properties at the film surface change and the angle of SPR changes accordingly. Because of this phenomenon, the angle of incidence is a direct measure of the characteristics at the surface of the thin film.

From these properties, various reactions of the thin film can be detected and measured by the varied reflective energy of the reflected light. For instance, the adsorption of various organic compounds can be measured on the surface of the thin film.

For example, the diffusion of proteins once the proteins are adsorbed to the surface can be measured. Bovine serum albumin (BSA) adsorbed to a section of a glass cover slip, while exposing the remainder of the cover slip only to protein-free buffer, advanced with the passage of time (Dt)^{1/2} with a dependence consistent with a diffusion type phenomenon. Diffusion across a gradient (a region in which the concentration of a substance changes over distance) could be described by a Fickian analysis (Transport Phenomena, R. Byron Bird, Warren E. Stewart, & Edwin N. Lightfoot, John Wiley & Sons, New York, 2^{nd} Edition, 2002). The self-diffusion coefficient of BSA on a quartz surface using fluorescence recovery after patterned photobleaching (FRAPP) techniques has been determined (Burghardt, T. P.; Axelrod, D., Biophys. J., 1981, 33, 455467). The results have been confirmed and extended to polymer surfaces (Tilton, R. D.; Robertson, C. R.; Gast, A. P. J. Colloid Interface Sci. 1990, 137, 192-203). Surface diffusion in other systems such as membrane proteins (Scallettar, B. A.; Abney, J. R.; Owicki, J. C., Proc. Natl. Acad. Sci. U.S.A. 1988, 85(18), 6726-6730; Abney, J. R.; Scallettar, B. A.; Owicki, J. C., Biophys. J., 1989, 55(5), 817-833; Abney, J. R.; Scallettar, B. A.; Owicki, J. C., Biophys. J., 1989, 56(2), 315-326), proteins adsorbed to the surface of chromatography resins (Ma, Z; Whitley, R. D.; Wang, N. H. L., AIChE J., 1996, 42(5), 1244-1262; Chen, W. D.; Dong, X. Y.; Sun, Y., J. Chromatogr. A, 2002, 962(1-2), 29-40), and DNA oligonucleotides at solid/liquid interfaces (Chan, V.; Graves, D. J.; Fortina, P.; Mckenzie, S. E., Langmuir, 1997, 13(2), 320-329; Chan, V.; Mckenzie, S. E.; Surrey, S; Fortina, P.; Graves, D. J., J. Colloid Interface Sci. 1998, 203(1), 197-207) has been studied.

Many varied techniques including forced Rayleigh techniques (Antonietti, M.; Coutandin, J.; Grütter, R.; Sillescu, H. Macromolecules 1984, 17, 798; Ehlich, D.; Takaneka, M.; Hashimoto, T., Macromolecules, 1993, 26(3), 492498) and NMR (Foy, B. D.; Blake, J., Journal of Magnetic Resonance, 2001, 148(1), 126-134) have been used to probe protein lateral mobility, but the most prevalent experimental tool has been FRAPP or the related procedure, TIR-FRAPP (total internal reflection—fluorescence recovery after patterned photobleaching). FRAPP entails working with a fluorescently labeled protein (or other macromolecule) adsorbed to a surface. A high intensity pulse of laser light is shined on sections of the surface photobleaching all chromophores within those regions. Any recovery of fluorescence intensity in the photobleached areas can be correlated to surface diffusion of the adsorbed fluorescently labeled proteins. FRAPP results are highly reproducible, and it appears FRAPP effectively measures surface diffusion on a wide variety of materials. TIR-FRAPP allows one to illuminate molecularly thin surface layers of fluroescent material using total internal reflection of an incident laser beam. As such, the illumination source does not interact with fluroescent materials in the bulk and restricts interrogation to the very near surface regions. This feature enhances the surface sensitivity of the measurement.

The main problems with FRAPP related techniques are that a protein must be labeled, which can lead to artificial adulteration of its three dimensional structure, that FRAPP cannot effectively probe gradient diffusion (i.e. the movement of a substance from a region of high to a region of low concentration) and that FRAPP requires the protein to be irreversibly adsorbed to the surface. FRAPP cannot distinguish between pure surface diffusion and protein desorption followed by subsequent bulk diffusion and reattachment at a different spot on the surface if the protein is weakly adsorbed such that there is some exchange with the bulk.

Surface diffusion plays an important role in the interaction of enzymes with biopolymers in the β-amylase starch gel system. Surface diffusion, rather than adsorption or intrinsic reactivity, is the deciding factor in proteolytic cleavage of substrate surfaces (Brode, P. F.; Erwin, C. R.; Rauch, D. S.; Barnett, B. L.; Armpriester, J. M.; Wang, E. S. F.; Rubingh, D. N., Biochemistry 1996, 35, 3162-3169). TIR-FRAPP can be used to measure the surface diffusion of collagenase irreversibly adsorbed to and reacting with a collagen surface (Gaspers, P. B.; Robertson, C. R.; Gast, A. P., Langmuir 1994, 10, 2699-2704). FRAPP can be used to quantify the surface diffusion rate of cellulase interacting with a cellulose surface (Jervis, E. J.; Haynes, C. A.; Kilburn, D. G., J. Biol. Chem. 1997, 272(38), 24016-24023). In each of the above cases, the enzyme was adsorbed to the surface so that there was little or no exchange with the bulk, thus making the FRAPP results reliable.

Microfluidic systems can be made to miniaturize traditional benchtop operations into miniature lab-on-a-chip type systems. Assays as varied as enzyme kinetics (Hadd, A. G.; Raymond, D. E.; Halliwell, J. W.; Jacobson, S. C.; Ramsey, J. M., Anal. Chem. 1997, 69, 3407-3412; Duffy, D. C.; Gillis, H. L.; Lin, J.; Sheppard, N. F.; Kellogg, G. J., Anal. Chem. 1999, 71, 4669-4778; Hadd, A. G.; Jacobson, S. C.; Ramsey, J. M., Anal. Chem. 1999, 71, 5206-5212), capillary electrophoresis (Khandurina, J.; McKnight, T. E.; Jacobson, S. C.; Waters, L. C.; Foote, R. S.; Ramsey, J. M., Anal. Chem. 2000, 72, 2995-3000), immunoanalysis (Hatch, A.; Kamholz, A. E.; Hawkins, K. R.; Munson, M. S.; Schilling, E. A.; Weigl, B. H.; Yager P. A., Nature Biotechnology 2001, 19, 461-465; Eteshola, E.; Leckband, D., Sensors and Actuators B-Chemical 2001, 72, 129-133; Cheng, S. B., Anal. Chem. 2001, 73, 1472-1479; Yang, T. L.; Jung, S. Y.; Mao, H. B.; Cremer, P. S., Anal. Chem. 2001, 73, 165-169), isoelectric focusing (Macounova, K.; Cabrera, C. R.; Holl, M. R.; Yager, P., Anal. Chem. 2001, 72, 3745-310; Macounova, K.; Cabrera, C. R.; Yager, P., Anal. Chem. 2001, 73, 1627-1633) and others have been performed on microfluidics platforms. The basis for microfluidic techniques is in fact a very simple outcome of low Reynolds number hydrodynamics. The Reynolds number is a dimensionless quantity defined as:

$$Re = \frac{ρ UD}{μ}$$

where ρ is the fluid density, U the average velocity, D a characteristic length for the system and μ the fluid viscosity (Transport Phenomena, R. Byron Bird, Warren E. Stewart, & Edwin N. Lightfoot, John Wiley & Sons, New York, 2^{nd} Edition, 2002). The Reynolds number also represents a ratio of inertial to viscous forces. In a microfluidic system, since all system dimensions are small, the Reynolds number is low. Accordingly, the fluid essentially has no inertia and acts as though it were “massless.” Such properties of fluid flow may be used according to the principles of the current invention.

A primary consequence of the low Reynolds flows is that multiple fluid streams can be made to flow side-by-side one another with minimal mixing between or among these streams. Indeed, the only mixing of components can be due to diffusion across the boundaries separating the multiple fluid streams. This diffusional mixing in turn can be minimized by flowing the streams at high velocities while at the same time not violating the constraint of maintaining a low Reynolds number.

As an example of this, a low Reynolds number phenomena has been used to measure a variety of molecular phenomena within the interdiffusion regions (i.e. the regions where diffusional mixing is occurring) at fluid-fluid interfaces in an embodiment known as the T sensor (Kamholz, A. E.; Weigl, B. H.; Finlayson, B. A.; Yager, P., Anal. Chem. 1999, 71(23), 5340-5347; Ismagilov, R. F.; Stroock, A. D.; Kenis, P. J. A.; Whitesides, G. M.; Stone, H. A.,

Appl. Phys. Lett. 2000, 76(17), 2376-2378). The width of this interdiffusion region can be simply calculated by the relation:
xᵣₘₛ=\sqrt{2Dt}

where xᵣₘₛ is the root mean squared distance traveled by a molecule in a time t with diffusion coefficient D (Kamholz, A. E.; Weigl, B. H.; Finlayson, B. A.; Yager, P., Anal. Chem. 1999, 71(23), 5340-5347). The time t is thus given by a characteristic time that is dependent on the distance along the channel (L) and the flow velocity (U) by the relation

$$t = \frac{L}{U}$$

rather than an actual time. The use of low Reynolds number flow to pattern surfaces has been described (Takayama, S.; McDonald, J. C.; Ostuni, E.; Liang, M. N.; Kenis, P. J. A.; Ismagilov, R. F.; Whitesides, G. M., Proc. Natl. Acad. Sci. U.S.A. 1999, 96(10), 5545-5548; Kenis, P. J. A.; Ismagilov, R. F.; Whitesides, G M, Science 1999, 285, 83-85; Duffy, D. C.; McDonald, J. C.; Schueller, O. J. A.; Whitesides, G. M., Anal. Chem. 1998, 70(23), 4974-4984). The relations change somewhat near the surface (diffusion distance follows a (DHt)^{1/3} rather than a (Dt)^{1/2} dependence) but the same principles hold (Takayama, S.; McDonald, J. C.; Ostuni, E.; Liang, M. N.; Kenis, P. J. A.; Ismagilov, R. F.; Whitesides, G. M., Proc. Natl. Acad. Sci. U.S.A. 1999, 96(10), 5545-5548). For example, a three inlet channel to pattern E. coli cells in alternating stripes on a substrate surface has been shown (Takayama, S.; McDonald, J. C.; Ostuni, E.; Liang, M. N.; Kenis, P. J. A.; Ismagilov, R. F.; Whitesides, G. M., Proc. Natl. Acad. Sci. U.S.A. 1999, 96(10), 5545-5548).

Soft lithography is a popular, reliable technique for producing microfluidic devices (Duffy, D. C.; McDonald, J. C.; Schueller, O. J. A.; Whitesides, G. M., Anal. Chem. 1998, 70(23), 4974-4984). It makes use of an elastomeric material known as polydimethylsiloxane (PDMS) that is both flexible enough to seal against most types of substrate surfaces and rigid enough to maintain channel structures. The technique incorporates photolithography methods that have been used for years in the semiconductor industry into a micromolding scheme that eventually produces micron sized structures in negative relief in PDMS (see, Duffy, D. C.; McDonald, J. C.; Schueller, O. J. A.; Whitesides, G. M., Anal. Chem. 1998, 70(23), 4974-4984 and for example, FIG. 2).

Initially, a clean dry silicon wafer is spin coated with a layer of photoresist (typically SU8, Microchem Inc.) equal to the desired thickness of the microchannel. A mask containing the pattern of microfluidic structures is then placed over the wafer and exposed to ultraviolet light. Because photoresist is photosensitive, it will crosslink in the areas exposed to the light and thus when submerged in developer solution, only the exposed regions of photoresist remain on the wafer. This pattern of photoresist thus serves as the mold for the next micromolding step. A PDMS prepolymer along with a curing agent are then cast on the pattern containing wafer. At an elevated temperature, the PDMS cures, producing a soft flexible material with the channels embedded in negative relief. The PDMS is peeled back from the wafer and then sealed against the substrate of choice. Holes are made at the inlets and outlets of the PDMS piece to allow delivery of reagents to and from the newly formed microfluidic chip.

Thus, what is needed in the art is a system that can measure multiple molecular interactions quickly and efficiently. What is also needed in the art is a method for making use of microfludics to pattern areas of the substrate surface that are accessible to an enzyme.

### SUMMARY OF THE INVENTION

Disclosed is a device for measuring surface plasmon resonance and fluorescence of a sample, comprising a light source capable of directing a beam of light at a sample cell, where the sample cell comprises a first compound bound to a metallic surface; a first detector for measuring the surface plasmon resonance from the metal surface; a second detector for measuring the fluorescence intensity from the surface; and a module for calculating the combined adsorption of two species from the surface plasmon resonance measurement and the fluorescence intensity measurement.

Also disclosed is a system for quantifying the properties of molecules. Specifically, an aspect disclosed is a system for determining the rate of surface catalytic activity of an enzyme; comprising a light source capable of directing a beam of light at a sample cell, where the sample cell comprises a fluorescent compound bound to a metallic surface; a first detector for taking a surface plasmon resonance measurement of the surface in the sample cell as an enzyme is contacted with the compound; a second detector for taking a fluorescence intensity measurement of the compound as the enzyme is contacted with the compound; and a module for calculating the catalytic activity of the enzyme from the surface plasmon resonance measurement and the fluorescence intensity measurement.

In addition, a method is disclosed for determining the rate of catalytic activity of an enzyme, comprising providing a sample cell comprising a fluorescently labeled compound is bound to a metallic surface; flowing an enzyme sample through the sample cell; measuring the surface plasmon resonance of the sample cell over time to determine the amount of the enzyme that is bound to the first fluorescently labeled compound; measuring the fluorescence of the first fluorescently labeled compound over time to determine the amount of the first fluorescently labeled compound bound to the metallic surface; and calculating the catalytic activity of the enzyme from the surface plasmon resonance measurement and the fluorescence intensity measurement.

Furthermore, disclosed is a method of measuring the adsorption of multiple substances, comprising a) exposing said first substance on a thin metal layer of a top window of a sample cell to a first beam of light from a light source; b) detecting a reflection of the first beam of light with a reflectivity detector, thereby taking a surface plasmon resonance measurement; c) detecting a fluorescence light from the first substance with a fluorescence intensity detector; d) contacting a second substance with the first substance to provide a mixture; e) exposing the mixture to a second beam of light from a light source; f) detecting a reflection of the second beam of light with a reflectivity detector, thereby taking a surface plasmon resonance measurement; g) detecting a fluorescence light from the mixture with a fluorescence intensity detector; and h) comparing the results of the detections of steps b) and c) with the detections of steps e) and g).

Additionally disclosed is a device for measuring diffusion and reactivity comprising a surface for flowing at least two interfacing fluid streams and for creating and relaxing surface gradients in the at least two fluid streams, at least one stream containing macromolecules, the macromolecules interacting with the surface, wherein the flow has a low Reynolds number so that the at least two fluid streams do not mix; and a detector. The at least two interacting streams can be three or five streams. More streams can be envisioned. The device is particularly suited for use with macromolecules. Furthermore, the device can be practiced wherein the detector comprises fluorescence microscopy, plasmon imaging, ellipsometric imaging, brewster angle microscopy, total internal reflection microscopy, FRAPP or a combination of any of the above. The surface of the device may comprise surfaces that are plastics, polymers, SAMS (self-assembled monolayers), lipid bilayers, glass, transparent materials, reflective materials, gold, biomaterials or biodegradable materials.

Finally, disclosed is method for measuring diffusion and reactivity comprising flowing at least two interfacing fluid streams on a surface, at least one stream containing macromolecules, the macromolecules interacting with the surface, wherein the flow has a low Reynolds number so that the at least two fluid streams do not mix; creating and relaxing surface gradients as a result of flowing of the at least two fluid streams and detecting diffusion and reactivity. The at least two interacting streams can be three or five streams. More streams can be envisioned according to the invention. The method is particularly suited for use with macromolecules. Furthermore, the method can be practiced wherein the detecting step further comprises fluorescence microscopy, plasmon imaging, ellipsometric imaging, brewster angle microscopy, total internal reflection microscopy, FRAPP or a combination of any of the above. The surface may comprise surfaces that are plastics, polymers, SAMS, lipid bilayers, glass, transparent materials, reflective materials, gold, biomaterials or biodegradable materials.

### BRIEF DESCRIPTION OF THE DRAWINGS

FIG. 1 is a schematic view of an embodiment of a system that can be used for conducting multiple tests simultaneously and recording and analyzing any corresponding test results.

FIG. 2 is a schematic view of a test apparatus of the system of FIG. 1.

FIG. 3 is a schematic view of a sample cell of the apparatus of FIG. 2.

FIG. 4 is a schematic view of the modules of a computer that can be implemented in the system of FIG. 1.

FIG. 5 is a flow chart of a process that can be used to normalize measured values of reflectance in the system of FIG. 1.

FIG. 6 shows (a) a typical surface plasmon spectrum for the interface between gold (n=0.17216, k=3.4218) and 2 mM carbonate buffer (n=1.335). (b) Shift to a higher resonance angle in the surface plasmon curve upon formation of BSA monolayer (n=1.57). The arrow indicates the angle of maximum vertical resolution (56.5°).

FIG. 7 shows a sample surface plasmon signal before (a) and after (b) normalization by the reference gold-air signal. A substantial improvement in the surface plasmon image quality is observed.

FIG. 8 depicts a biotin/avidin binding experiment. In (a), a monolayer of labeled avidin is bound to a biotin surface. In (b), an incomplete monolayer of labeled avidin is formed followed by completion of the layer by unlabeled avidin. In (c), the first avidin layer is left unlabeled and another layer of fluorescently labeled biotin-BSA is bound to the avidin surface.

FIG. 9 shows the results of the first experiment described in FIG. 8a. The graph in (a) depicts the time course of the experiment. The inset shows the linear correlation between the two signals.

FIG. 10 shows (a) an incomplete monolayer experiment in which first fluorescent avidin is flowed over the biotin surface and then non-fluorescent avidin. No rise in SPEF is seen upon addition of the unlabeled avidin. (b) The corresponding control experiment in which fluorescently labeled avidin has been added at both steps.

FIG. 11 shows the results of (a) a biotin/avidin/BSA sandwich experiment in which only BSA is fluorescently labeled. The SPEF signal only rises in the second step.

The inset shows the amounts of BSA and avidin present on the surface separately (b) Corresponding control experiment in which neither component is labeled.

FIG. 12 shows the results of a PMSF inhibited enzyme experiment. Arrows indicate time of addition. The displacement in the signal following addition of inhibited enzyme indicates enzyme adsorption. The decrease in SPR signal after addition of active enzyme confirms the presence of BSA on the surface.

FIG. 13 shows channel geometry where two fluids are flown together.

FIG. 14 shows steps used in soft lithography.

FIG. 15 shows channel geometry where fluids are flown with fluorescent BSA as the surface substrate. The figure shows that initially a thickness profile of the surface will be flat when two fluids are flown together. Enzyme solution in the bulk is localized to the middle lane, and any widening of the trench is due to surface diffusion as it reacts away surface bound protein.

FIG. 16 shows a flow scheme according to an embodiment of the invention.

FIG. 17 shows a five lane apparatus with a negative pressure “pull” configuration.

FIG. 18 shows the results of a three lane experiment with enzyme flowed down the middle lane. FIG. 18a shows the results, with the beginning of the trench, caused by enzymatic erosion of the surface, visible. FIG. 18b shows intensity profiles across the channel. After two hours of flow, considerable widening of the trench can be seen.

FIG. 19 shows the results of a five lane experiment with the results flowed down the middle. FIG. 19a shows flaring out; FIG. 19b shows the alteration of the structure of the junction to overcome the flaring out, as shown in FIG. 19b; FIG. 19c shows the is improvement as a result of the improved channel.

FIG. 20 shows the results of a five lane assay using subtilisin and a G100R mutant. The positive mutant is seen to be slower reacting and less mobile on the surface than the corresponding wildtype subtilsin enzyme.

### DETAILED DESCRIPTION OF THE PREFERRED EMBODIMENTS

Embodiments of the invention will now be described with reference to the accompanying figures, wherein like numerals refer to like elements throughout. The terminology used in the description presented herein is not intended to be interpreted in any limited or restrictive manner simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

One embodiment of the invention is a system and method for simultaneously measuring surface plasmon resonance and surface plasmon enhanced fluorescence during a molecular interaction. As is discussed in detail below, a molecular interaction includes interactions between any species of chemical, biological or other compound. As used herein, “molecular” includes inorganic and organic chemical compounds, proteins, peptides, antibodies, antigens, enzymes and the like. Advantageously simultaneous measurement of both SPR and SPEF permits researchers to measure two or more species or properties of the molecular interaction at the same time. For example, an enzymatic substrate can be fluorescently labeled and bound to a thin film surface. An SPR measurement can then be taken to reveal the quantity of substrate bound to the surface. After the quantity is determined, an appropriate enzyme can be added to the reaction and a measurement of the SPR and SPEF of the reaction over time can be taken. Because the SPEF will measure the amount of fluorescently labeled substrate in the reaction, and the SPR will determine the amount of enzyme bound to substrate at the surface of the thin film, a reaction rate can be calculated. Of course, this is only one example of the type of complex molecular interaction that can be measured by embodiments of the invention. The system and methods described herein allow new testing methods to determine the reaction kinetics of one or more compounds where the compounds have different properties that can each independently vary the SPR outcome, the SPEF outcome or both. For instance, two compounds, one of them being fluorescent, can be reacted in a mixture. SPR can then be used to measure the reactions of both, while SPEF only measures the reaction of the fluorescent material. By taking the difference between the SPR measurement and the SPEF measurement, the reaction rate of the non-fluorescent material can be determined.

Another embodiment is a system and method for measuring diffusion and reactivity of macromolecules on a surface. This aspect, for example, allows direct observation of the lateral diffusivity of the enzyme as it cleaves substrate from the surface and allows observation of the properties without adulteration of the enzyme structure by, for example, labeling (e.g., fluorescent and radioactive labeling). Specific embodiments include a microfluidic patterning technique for the label-free measurement of an enzyme's lateral diffusivity as it interacts with a substrate surface.

Another embodiment is drawn to a method of enhancing the performance of enzymes such as cellulase, amylase, protease, polyesterase, lipase, mannanase, cutinase, oxidases etc that reacts with substrates that are bound to a surface or solid substrates. Proteolytic removal of a protein from a given surface will depend on the enzyme adsorption to the substrate surface, diffusion of the adsorbed enzyme on the substrate surface and the inherent proteolytic activity of the enzyme. A protease that adsorbs to the surface but cannot diffuse on the surface will not be very efficient in removing the protein from the surface. Similarly a protease that does not adsorb to the surface will not be very efficient in removing the protein from the surface. Therefore, there is an optimum adsorption for optimal performance (removal of protein from the surface) that is between 20% and 80% of the protease in solution (especially useful for applications that use low enzyme concentrations). In the same way, there is an optimal diffusion that is required for performance which is greater than 10% but less than 60% of the theoretical maximum for a molecule that does not have any specific interaction with the protein surface. Therefore protease molecules of a given proteolytic activity with the above mentioned limits of adsorption and diffusion will yield the maximum protein removal from the substrate surface. Once the adsorption and diffusion are not limiting the performance, then, the inherent proteolytic activity can be improved. This cycle can be repeated until the desired performance is achieved.

I. Aspects of the Invention

Disclosed is a system for quantifying the properties of molecules. Specifically, in a first aspect, embodiments of the present invention relate to a device for measuring surface plasmon resonance and fluorescence of a sample, comprising a light source capable of directing a beam of light at a transparent prism bound to a metallic surface; a first detector for measuring the surface plasmon resonance of the metallic surface; a second detector for measuring the fluorescence intensity from the sample; and a module for calculating the adsorption or catalytic activity of the enzyme from the surface plasmon resonance measurement and the fluorescence intensity measurement.

In certain embodiments, the metallic surface of the above device is formed over a piece of glass. The metallic surface may be made up of one single metal, or may comprise two or more different metals in the form of alloys. In some embodiments, a second layer of metal may be placed between the glass surface and the metallic surface, where the two layers of metal are made up of different types of metals.

In certain embodiments, the metallic surface may comprise a transition metal. A “transition metal” is a metal within columns 3-12 of the periodic table. Some main group metals are also suitable for use as the metallic surface. Some of the metals contemplated within the scope of the invention include scandium, titanium, vanadium, chromium, manganese, iron, cobalt, nickel, copper, zinc, gallium, yttrium, zirconium, niobium, molybdenum, technetium, ruthenium, rhodium, palladium, silver, cadmium, indium, tin, lanthanum, hafnium, tantalum, tungsten, rhenium, osmium, iridium, platinum, gold, mercury, thalium and lead. The metal may be in its elemental form or in a compound form. In some embodiments, the metal is selected from the group consisting of gold, silver, mercury, titanium, which may be in titanium dioxide form and copper. In other embodiments, the metal is gold.

In certain embodiments, the first compound is attached directly to the metallic surface. In other embodiments, the first compound may be attached to a linker arm, which in turn is attached to the metallic surface. In some embodiments, the linker arm may form a monolayer, such as a self-assembled monolayer. The monolayer may then comprise a functional group to which the first compound can be attached. Methods of formation of self-assembled monolayers on metallic surfaces is known to those of skill in the art. See, for example, Nuzzo, R. G.; Allara, D. L. J. Am. Chem. Soc. 1983, 105, 448; Bain C. D.; Troughton, E. B.; Tao, Y.-T.; Evall, J.; Whitesides, G. M.; Nuzzo, R. G. J. Am. Chem. Soc. 1989,111,321-335; and Ulman, A. Chem. Rev. 1996, 96, 1533; all of which are incorporated by reference herein in their entirety, including any drawings.

In some embodiments, the sample compound is an enzyme and the first compound is a substrate for the enzyme, while in other embodiments the first compound is an enzyme and the sample compound is a substrate for the enzyme.

Embodiments of the invention include those in which the sample compound is contacted with the first compound. In some embodiments, neat sample compound, i.e., sample compound that is not dissolved in any solutions or diluted in any way, is added directly to the metallic surface, to which the first compound is attached.

In other embodiments, the sample compound is mixed with a carrier. The carrier, and the sample compound contained therein, are then passed over the metallic surface comprising the first compound. The carrier may be a liquid carrier or a gas. If the carrier is a liquid, then the carrier and the sample compound form a solution and the solution is passed over the metallic surface. If the carrier is a gas, then the carrier and the sample compound form a gaseous mixture, which is then passed over the metallic surface. In some embodiments, the carrier is a liquid. In certain embodiments, the carrier is an aqueous solution. In other embodiments, the carrier comprises an organic solvent. Thus, in certain embodiments, the solution comprising the sample compound flows through the sample cell, thereby causing the first compound and the sample compound to come into contact with each other. This would work for other applications beyond enzymes.

In some embodiments the first detector is a reflectance detector, which detects light reflected from the sample cell. In certain embodiments the first detector is a charge couple device, or CCD, detector.

In some embodiments, the first detector measures the surface plasmon resonance of the metallic layer as a sample compound is contacted with the first compound. In certain embodiments, the second detector measures the fluorescence intensity from the sample cell as the sample compound is contacted with the first compound.

In certain embodiments, the angle the reflected light makes with the normal of the sample cell is substantially equal to the angle the beam of light from the light source makes with the normal of the prism. In some embodiments, the sum of the angle the reflected light makes with the normal of the prism and the angle the beam of light from the light source makes with the normal of the prism is less than 180°. In these embodiments the first detector may detect any variations in the angle the reflected light makes with the normal of the prism.

Embodiments of the invention include those in which the second detector is a fluorescence detector which detects fluorescence from the sample cell. The second detector may be located on the opposite side of the sample cell as the light source.

In some embodiments, the first compound fluoresces after being illuminated by the light, whereas in other embodiments the sample compound fluoresces after being illuminated by the light.

The light used in some embodiments of the invention may be monochromatic. The light source used may be a laser light source.

In certain embodiments, the device further comprises at least one mirror, at least one prism, at least one collimator, or at least one lens, or a combination thereof, between the light source and the sample cell.

In certain embodiments, the module comprises a microprocessor. The module may also comprise a memory. Additionally, the module may comprise a set of computer implemented instructions.

In another aspect, the present invention relates to a system for determining the rate of catalytic activity of an enzyme; comprising a light source capable of directing a beam of light at a prism, where the prism is bound to a fluorescent compound bound to a metallic surface; a first detector for taking a surface plasmon resonance measurement of the sample cell as an enzyme is contacted with the compound; a second detector for taking a fluorescence intensity measurement of the compound as the enzyme is contacted with the compound; and a module for calculating the catalytic activity of the enzyme from the surface plasmon resonance measurement and the fluorescence intensity measurement.

In a further aspect, the invention relates to a method of determining the rate of catalytic activity of an enzyme, comprising providing a sample cell comprising a fluorescently labeled compound bound to a metallic surface; flowing an enzyme sample through the sample cell; measuring the surface plasmon resonance of the sample cell over time to determine the amount of the enzyme that is bound to the first fluorescently labeled compound; measuring the fluorescence of the first fluorescently labeled compound over time to determine the amount of the first fluorescently labeled compound bound to the metallic surface; and calculating the catalytic activity of the enzyme from the surface plasmon resonance measurement and the fluorescence intensity measurement.

In another aspect, the invention relates to a method of measuring the adsorption of multiple substances, comprising a) exposing the first substance on a thin metal layer of a top window of a sample cell to a first beam of light from a light source; b) detecting an intensity of a reflection of the first beam of light with a light detector, thereby taking a surface plasmon resonance measurement; c) detecting a fluorescence light from the first substance with a fluorescence intensity detector; d) contacting a second substance with the first substance to provide a mixture; e) exposing the mixture to a second beam of light from a light source; f) detecting a reflection of the second beam of light with a reflectivity detector, thereby taking a surface plasmon resonance measurement; g) detecting a fluorescence light from the mixture with a fluorescence intensity detector; and h) comparing the results of the detections of steps b) and c) with the detections of steps e) and g).

In another embodiment, the invention is directed to a device and method for measuring diffusion and reactivity of macromolecules on a surface. This embodiment, for example, allows direct observation of the lateral diffusivity of the enzyme as it cleaves substrate from the surface, which permits observation of properties without adulteration of the enzyme structure by, for example, labeling (e.g., fluorescent, radioactive, etc.). Specific embodiments include a microfluidic patterning technique for the label-free measurement of an enzyme's lateral diffusivity as it interacts with a substrate surface.

In another embodiment, the invention is directed to a method for identifying enzymes that perform optimally on substrate surfaces and the optimized enzymes.

Since the above methods are practiced using the devices described herein, all of the various embodiments described herein with respect to the disclosed devices similarly apply to the disclosed methods and procedures.

II. Overview

Certain systems and methods of the present invention are particularly suited for measuring multiple variables in a molecular reaction at the same time. The mechanism of many such reactions comprise multiple steps. Usually, one of the steps is slower than others and is known as the rate-determining step. Step(s) before the rate-determining step are normally in equilibrium, called “pre-equilibrium.” By knowing the rate constants of the forward and reverse reactions in the pre-equilibrium, and the rate constant of the rate-determining step, the overall rate law for the reaction can be determined.

In certain embodiments of the present invention, a first compound is affixed to a thin metal layer on a glass slide. The first compound can be an enzyme, a protein, a substrate for an enzymatic reaction, or one of the reactants of a reaction. In some embodiments disclosed herein, the first compound is called “the sample compound” or “the first compound.”

The first compound may be fluorescent. Its fluorescence may be inherent, i.e., the first compound itself fluoresces, or a fluorescent substituent may be attached to the first compound prior to its affixation to the glass slide. The first compound may have more than one fluorophore attached to it, thus providing the ability to measure its fluorescence at multiple wavelengths. In other embodiments, the first compound is not fluorescent.

There are various ways the first compound may be affixed to the glass slide. The first compound may be made to react directly with the thin metal layer. Thus, for example, a self-assembled monolayer of the first compound can be formed on the thin metal layer. In other embodiments, the first compound may be able to react with a functional group on an anchor attached to the thin metal layer. Thus, for example, a self-assembled monolayer comprising a functional group can be attached to the thin metal layer, forming an anchor, and then the first compound is made to react with that functional group, thereby being affixed to the glass slide through the anchor. Alternatively, the first and second compound can be adsorbed simultaneously as well.

SPR and SPEF measurements are made of the glass slide while the first compound is affixed thereto. These measurements determine the baseline for the measurements. The SPR measurement determines the thickness of the chemical layer on the thin metal layer and the SPEF measurement determines the maximum fluorescence of the sample prior to any reaction taking place. Alternatively, the SPEF can measure the minimum fluorescence of the sample prior to any reaction taking place. A change in either or both of these measurements will then determine the extent of reaction involving either the thickness of the layer or the amount of fluorescence present.

A second compound, also referred to herein as “the test compound,” is then made to react with the first compound. The second compound may be an enzyme whose substrate is the first compound, may be a substrate for the first compound enzyme, or may be another reactant in the reaction being studied. The second compound may or may not be fluorescent. If fluorescent, its fluorescence may be inherent, i.e., the second compound itself fluoresces, or a fluorescent substituent may be attached to the second compound prior to the reaction taking place. The second compound may have more than one fluorophore attached to it, thus providing the ability to measure its fluorescence at multiple wavelengths.

When the second compound binds to the first compound in the course of the reaction, the thickness of the chemical layer on the thin metal layer changes. The layer becomes thicker. This increase in the thickness affects the measurement obtained by the SPR.

When the first and second compounds react, the fluorescence of the sample changes. The reaction between the two may be a cleaving reaction, meaning the first compound cleaves a part of the second compound, or vice versa. If the reaction is a cleaving reaction, then the fluorescence of the sample decreases, since one of the fluorophores attached to either the first or the second compound comes off and washes away. An example of this type of reaction may include the first compound being a protein, comprising fluorescent substituents attached thereto, and the second compound being a protease, which cleaves the protein into smaller pieces.

The change in the fluorescence of the sample causes a change in the SPEF measurement. The rate of change of the fluorescence in the sample can then be measured, which would be proportional to the rate of the reaction proceeding.

By comparing the measurements obtained from SPR and SPEF, one can determine how fast the two compounds bind to each other and how fast the reaction between them proceeds.

Certain systems and methods of the present invention are also particularly suited for measuring diffusion and reactivity of molecular reactions. Diffusion and reactivity can be measured by flowing at least two interfacing fluid streams on a surface creating and relaxing surface gradients as a result, at least one of the streams containing macromolecules, the macromolecules interacting with the surface, wherein the flow has a low Reynolds number so that the at least two streams do not mix and detecting the interactions. The system and method employ an assay that measures the surface diffusion of a macromolecule as it reacts with the substrate surface without altering the enzyme by labeling. Specifically, gradient diffusion is measured, which contrasts to self diffusion. Gradient (or mutual) and self diffusion are quite different from one another, as self diffusion is strictly due to thermal energy and gradient diffusion involves the relaxation of concentration fluctuations (or gradients); both can be limited by stronger interactions with the surface. This can specifically be done with microfluidic chips with three or five inlets flowing into a main channel in which the surface is covered by the protein substrate. More inlets are contemplated. Buffers are flowed down the outside lanes and enzymes through the middle, forming a stripe of enzyme down the middle of the substrate surface. The boundary between the enzyme lane and the buffers is kept relatively sharp by flowing at a high linear velocity (10-20 cm/s). Initially the thickness profile of the surface will be flat, but once enzyme flow begins, a trench will form, as the enzyme will cleave the substrate adjacent to the middle lane. Since the enzyme solution in the bulk is localized to the middle lane, any widening of this trench must be due to surface diffusion of the enzyme (i.e. relaxation of the enzyme concentration gradient) as it reacts away the surface bound protein.

The system and methods may be either a “push” or “pull” mechanism wherein the push mechanism makes use of an acrylic flow cell. The flow cell serves as the housing for a chip, allowing an introduction of fluids into the chip. The embodiment also contemplates a means to detect the interactions, as provided above. An optical system to image the interactions described may also be used. Possible methods for detection include plasmon, fluorescence, Brewster angle or ellipsometric imaging.

The examples below provide more specific situations where such measurements have taken place.

III. System

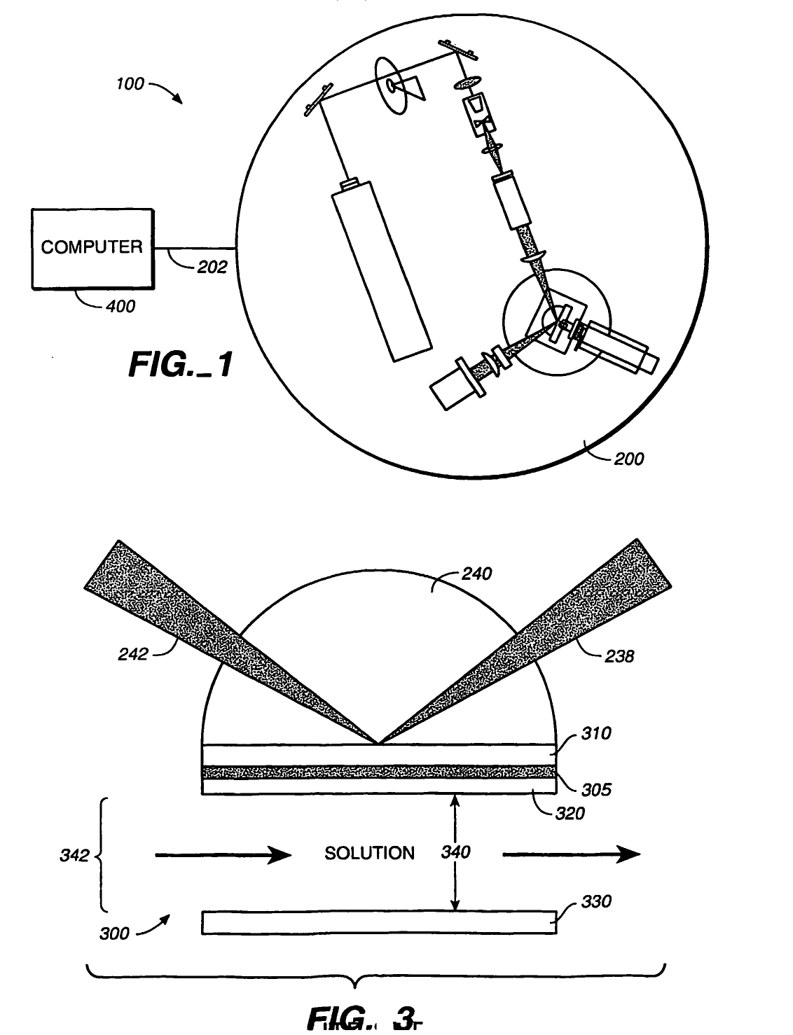

Disclosed is a system for quantifying the properties of molecules. Specifically, a system can be set up to perform and capture data from SPR and SPEF simultaneously. FIG. 1 illustrates one embodiment of such an apparatus. FIG. 1 illustrates a testing system 100 having a testing apparatus 200 and a computer 400. The testing apparatus 200 is in communication with the computer 400 through a data link 202 to operate and report on the tests being run. The computer 400 sends commands to the test apparatus 200 to control the test sequence and monitor parameters of the test. The test apparatus 200 sends data from the SPR and SPEF measurements to the computer 400 for storage and analysis.

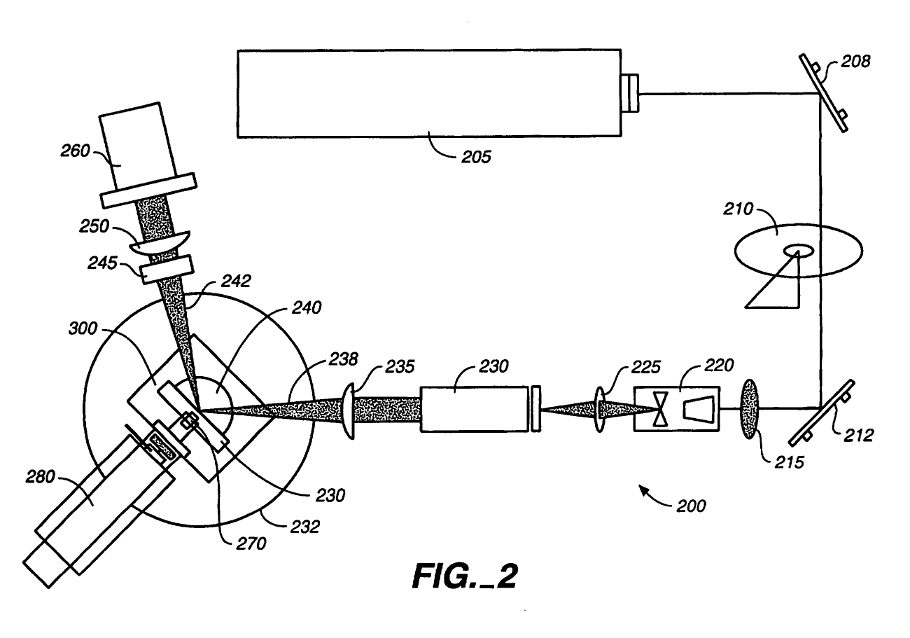

FIG. 2 illustrates an embodiment of the testing apparatus 200 that is suitable for use in performing the simultaneous testing for SPR and SPEF. A laser 205 provides a source of light to operate the test. The laser can be monochromatic or it may generate various wavelengths of light. Preferably, the laser is a 35 mW He—Ne laser. However, any light source can be used, such as a tunable light source or an omni-chromatic light source, i.e., a source capable of emitting all wavelengths of light simultaneously. The light is directed via mirrors 208, 212 through a neutral density filter 210 that controls the incident light intensity into the rest of the components.

The beam of light passes next through a plane polarizer 215, such as a Glan-Thomson polarizer, and then through a spatial filter 220. The spatial filter 220 gives the light a more homogeneous profile. The beam is then focused by a lens 225 into an expander/collimator 230 where the light is expanded to the proper beam width and the light rays are made parallel to one another.

The light is then directed into a test area 232 by a planar cylindrical lens 235 at an angle below the critical angle. The critical angle is an angle below which all of the incident light 238 is reflected out as reflected light 242. The incident light is directed to a sample cell 300 (shown in FIG. 3) by a hemi-cylindrical prism 240.

The incident light 238 passing through the prism 240 reflects off a surface 310 of the sample cell 300 and out of the prism 240. The reflected light 242 then passes through a second planar cylindrical focusing lens 250, which focuses the reflected light 242 onto a linear CCD array 260 which measures the intensity of the reflected light 242. A second neutral density filter 245 can also be used to attenuate the reflected light 242 to a level for which the photo detector is most linear or accurate. In the example illustrated in FIG. 2, a second neutral density filter 245 is used with a CCD array 260, although any photo detection device can be used. Furthermore, the focusing planar lens 250 is used to focus light reflecting at a multitude of angles onto the linear CCD array 260 in the embodiment illustrated in FIG. 2. However, it should be realized that a planar CCD array could be used as well to aggregate the light reflected at various angles. The two methods of vertically averaging, or aggregating the light reflected at the various angles, can be used but any other method of measuring the intensity of the total aggregated reflected light can be used. The light measured by the CCD array 260 corresponds directly to any resonance that occurs with the surface plasmons and, therefore, is used to calculate the SPR.

The SPEF is measured simultaneously with the SPR by a photo detector 280 capable of detecting fluorescent emissions from fluorescent samples in the sample cell 300. The illustrated embodiment uses a microscope objective lens 270 and a photomultiplier tube 280, but any other means of measuring fluorescent emissions can be used without departing from the spirit of the invention.

Referring to FIG. 3, one embodiment of the sample cell 300 is described for performing the SPR and SPEF tests. Again, although one embodiment of the sample cell 300 is illustrated in FIG. 3, any number of variations can be used. The illustrated embodiment includes a thin gold film 305 attached to the glass slide 310. In some embodiments the glass slide 310 is polished SF10 glass, but any glass can be used.

Some embodiments may also include another layer of a different metal below the thin gold film. The purpose of this second layer of metal is to provide better adhesion of the gold layer to the glass. A number of different metals can be used for this purpose, including, but not limited to, chromium, molybdenum, vanadium, niobium, tantalum and manganese. Preferably, the undercoat on the gold film includes chromium.

A functionalized anchor 320 is affixed to the thin film 305 and is designed to chemically react with other molecules that are to be attached to the thin gold film 305. The anchor may be in the form of self-assembled monolayers. The anchor may be affixed to the thin film 305 via a variety of different functional groups, such as, but not limited to, thiols, sulfoxides, sulfones, thiosulfates, disulfides, polydisulfides, alkylsulfides and the like. The anchor then presents a functional group, to which the first compound can be attached. Virtually any functionality can be presented by the anchor 320. In some cases, the functional group may be a reactive group such as an amine, carboxylate, sulfide or ester. In other instances, biological functionalities such as lipids, biotins, antibodies or ligand/receptor molecules may be presented at the surface. Generally, this specific functionality will determine the type of static or dynamic measurements to be performed.

After a test compound is attached to the functional group of the anchor 320, a solution comprising the sample compound is then contacted with the combination of glass 310, thin metal layer 305, anchor 320, and linked test compound. In some embodiments, the solution flows over the glass slide 310. In other embodiments, a lower glass slide 330 forms a flow area 340 between itself and the anchor 320 through which test solution can flow into and out of the test cell 300.

The gap between the lower glass slide 330 and the upper glass slide 310, or the height of the flow area 340, will depend on the test performed. The larger the gap, the more solution can pass through. However the ratio of the volume of the solution passing through the cell to the contact area with the test compound decreases as the gap becomes larger. Those of skill in the art can determine how large a gap is suitable for the type of test is being conducted. In certain embodiments, the gap is not larger than 1 cm. In other embodiments, the gap is less than 5 mm, less than 1 mm, or less than 0.5 mm.

In certain embodiments a gasket of a certain thickness is used between the glass slide 310 and lower glass slide 330 to create and hold the gap. The thickness of the gasket, then, determines the thickness of the gap. The gasket may be made of any number of materials, but preferably it is made of such material that are inert towards the solutions and the compounds used in the test. Examples include, but are not limited to, rubber, ceramic, silicone, TYGON, TEFLON and the like. Some embodiments preferably use a 0.5 mm silicone gasket to determine the gap.

The entire assembly 342 is then attached to the hemi-cylindrical prism 240 to generate the sample cell 300. In some embodiments the prism 240 will be made of the same glass type as the glass slide 310. In one embodiment, the glass is SF10 glass. Additionally, an index matching fluid is placed between the prism 240 and the glass slide 310 to prevent any refraction of laser light as it passes from the prism 240 to the glass slide 310. If an SF10 glass is used that has a refractive index of about 1.723, then one example of a liquid that can be used is a Series M liquid having a refractive index of about 1.730 from Cargille Laboratories, Inc., 55 Commerce Road Cedar Grove, N.J. 07009.

A solution is then passed through the flow area 340 using any flow generating mechanism capable of providing flow, such as a peristaltic pump or a gravity drain system, for example. Certain embodiments utilize a flow generating mechanism or means that provides steady and repeatable flow characteristics. An SPR of the sample cell 300 is established by activating the laser 205 and directing the incident light at the appropriate angle such that SPR commences, and then the compounds (not shown) the user desires to have react with the anchor 320 are added to the fluid. As mentioned above, as the compounds react with the anchor 320, the refractive index of the test surface 320, 305, 310 changes, thereby changing the SPR reflection angle. In some embodiments, the angle of incidence is changed to determine which angle the resultant intensity of the reflected light 242 is weakest thereby indicating the SPR angle at any time, commonly referred to as scanning. This SPR angle is tracked by repeatedly scanning as compounds react with the test cell anchor 320 and because the SPR angle corresponds to the refractive index of the sample cell test surface 320, 305, 310 at any time users can determine what reactions have occurred by the changes of the SPR angle.

In the embodiment illustrated in FIG. 2, changing the angle of incidence, or scanning, is not required as the planar focusing lenses 235, 250 focus the light at various angles onto the test surface 320, 305, 310 and then to the CCD array 260. Moreover, altering the angle of reflected light 242 is not required in embodiments utilizing a planar CCD array that can aggregate the intensity of the reflected light 242 over a range of angles. In one embodiment the range of angular width that can be captured by the second planar focusing lens 250 is approximately eight degrees. However, this range can be more or less without departing from the invention. Typical SPR scanning techniques show a dip in the intensity of the reflected light at the angle where resonance occurs. This angle changes as the refractive index of the anchor 320 surface changes from reactions with compounds in the fluid flowing through the test cell 300. To maintain the linearity of the SPR and SPEF readings, in embodiments not aggregating a range of angles of the reflected light 242, this angle is preferably tracked and accounted for as the test continues. However, in embodiments, aggregating reflected light 242 from a range of angles, the linearity between the tests is maintained as the total intensity of all the reflected light in the range of concern is measured. This light energy varies as photon energy is transferred to the surface plasmons and also to the fluorescent light emitting materials during SPEF.

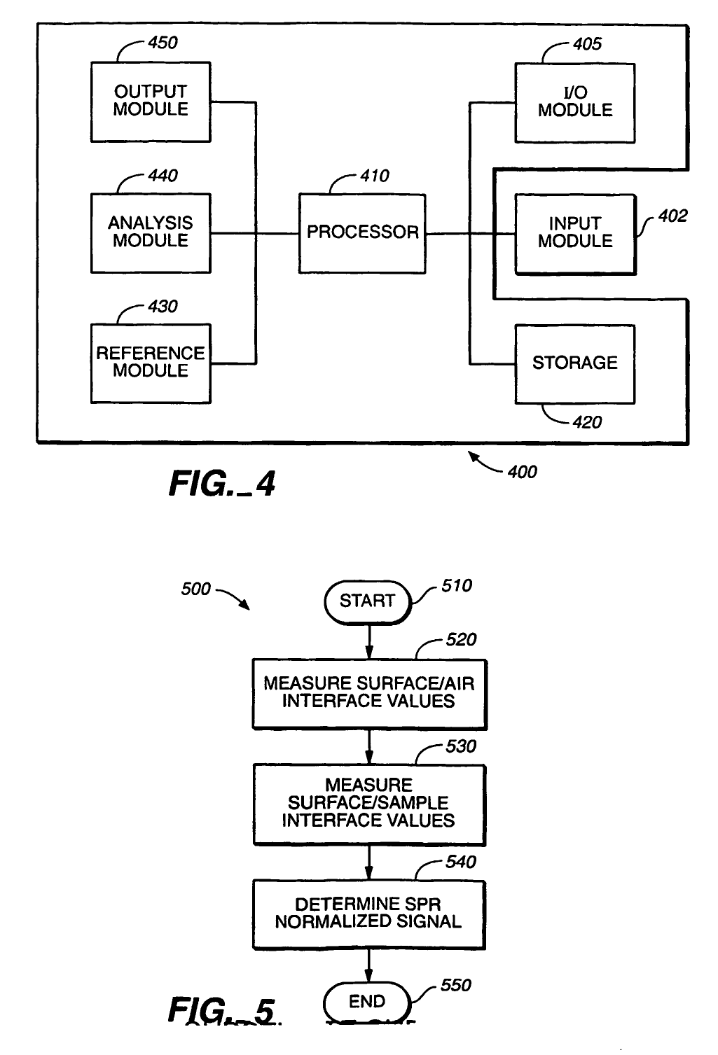

As mentioned above, a computer 400 is used to control and monitor the testing apparatus 200 for the SPR and SPEF procedures, as illustrated in FIGS. 1 and 4. The computer 400 fulfills several functions such as collecting and processing data, data analysis, storage, and various types of output. The computer 400 has several modules that fulfill these functions. However, it should be noted that the computer 400 can have more or less modules than are illustrated in FIG. 4. As can be appreciated by one of ordinary skill in the art, each of the modules can include various sub-routines, procedures, definitional statements and macros. Each of the modules can be separately compiled and linked into a single executable program. Therefore, the following description of each of the modules is used for convenience to describe the functionality of the computer 400. Thus, the processes that are undergone by each of the modules may be arbitrarily redistributed to one of the other modules, combined together in a single module, or made available in a shareable dynamic link library.

The computer 400 has an input device 402 that allows the operator to enter commands the computer 400 will execute. For example, the input device 402 may be a keyboard, rollerball, pen and stylus, mouse, or voice recognition system. The input device 402 may also be a touch screen associated with feedback provided by the computer 400. The user may respond to prompts on the display by touching the screen. The user may enter textual or graphic information through the input device.

The computer 400 also has an input/output module 405 for communication with the test apparatus 200 (FIGS. 2 and 4). The I/O module 405 provides for one-way or two-way communication and may provide simultaneous or ordered communication with the laser 205, the CCD array 260, the photomultiplier tube 280, or any other components of the test apparatus 200. The computer 400 may be in communication with the test apparatus 200 via a direct connection or via a network connection. The network connection may be a local area network, a wide area network or any other type of private or public network, such as the Internet. Alternatively, the computer 400 may be part of, or integral with, the test apparatus 200.

Still referring to FIG. 4, the computer has a processor 410 for executing many or all of the functions of the computer 400. The processor 410 may be any conventional general purpose single- or multi-chip microprocessor such as a Pentium® processor, a Pentium®) Pro processor, an 8051 processor, an MPS® processor, a Power PC® processor or an ALPHAS processor. In addition, the processor 410 may be any conventional special purpose microprocessor such as a digital signal processor. The computer 400 also includes a storage medium 420 for storing data or other information. The storage medium 420 can be any type of computer data storage medium including, but not limited to, RAM memory, DRAM memory, SDRAM memory, flash memory, ROM memory, EPROM memory, EEPROM memory, registers, hard disk, a removable disk or CD-ROM. The storage medium 420 is coupled to the processor 410 such that the processor 410 can read information from, and write information to, the storage medium 420. In the alternative, the storage medium 420 may be integral with the processor 410. The processor 410 and the storage medium 420 may reside in an Application Specific Integrated Circuit (ASIC).

As illustrated in FIG. 4, in addition to the modules described above, the computer 400 has special purpose modules that are directed to the testing of SPR and SPEF. These include a reference module 430, an analysis module 440 and an output module 450. In one embodiment the reference module 430 provides instructions for determining normalized readings of SPR and SPEF values rather than absolute values. Thus, the reference module 430 is configured to perform normalizing tasks, such as incorporating reference values into the data gathered from the SPR and SPEF procedures. The reference module 430 serves many data normalizing functions such as data normalization, test reference level determination and reflectance normalization. As described below, some embodiments utilize a normalized reflectance or an effective reflectance value rather than the actual or absolute reflectance taken during SPR or SPEF. The information required to perform such normalization processes is stored in, or performed by, the reference module 430.

Another module illustrated in FIG. 4 is the analysis module 440. The analysis module 440 provides the routines or subroutines necessary to process the data collected from a SPR or SPEF test to determine the results of the test in the format desired by the user. The analysis module 440 may be a slave module or include a coprocessor operated by the processor 410. Alternatively, it may be an independent module operating separately from the processor 410. Moreover, the analysis module 440 may be separate from the computer 400, such as in a separate processing device or in the testing apparatus 200.

The computer can also utilize the output module 450 to present feedback to the operator. The output module 450 may be part of the input module 402, such as in a touch screen to provide operational feedback as the operator is operating the computer 400. The method of output depends on the application and the desires of the operator and can be, for example, photo or electronic signals to be used by other devices, a plotter, a video output, a printer, a graphing device, a speaker or any other output device.

The various illustrative logical blocks, modules, and circuits described in connection with the embodiments illustrated by FIG. 4 and described herein may be implemented or performed with a general purpose processor, a digital signal processor (DSP), an application specific integrated circuit (ASIC), a field programmable gate array (FPGA) or other programmable logic device, discrete gate or transistor logic, discrete hardware components or any combination thereof designed to perform the functions described herein. A general purpose processor may be a microprocessor, but in the alternative, it may be any processor, controller, microcontroller or state machine. A processor may also be implemented as a combination of computing devices, e.g., a combination of a DSP and a microprocessor, a plurality of microprocessors, one or more microprocessors in conjunction with a DSP core or any other such configuration.

Reference values used in the testing process, and by reference module 430, can be obtained at different stages. However, some embodiments measure reference values of SPR and SPEF readings of the test sample cell 300 (FIG. 3) prior to passing any fluid across the test surface. FIG. 5 illustrates an exemplary normalization process 500 that can be part of the reference module 430 and can be used to determine an effective reflectance reading for the system. The process 500 begins at a start state 510 and moves to a first measuring state 520. At the first measuring state 520, the surface reflectivity of the sample cell is measured over the range of TIR angles. Values of reflectance are stored to the storage 420 when no liquid is flowing through the sample cell to provide a surface to air reading. This could be performed with a test surface to air measurement as described. However, a reference fluid, such as water, a buffer or a standard solution, may be used as well.

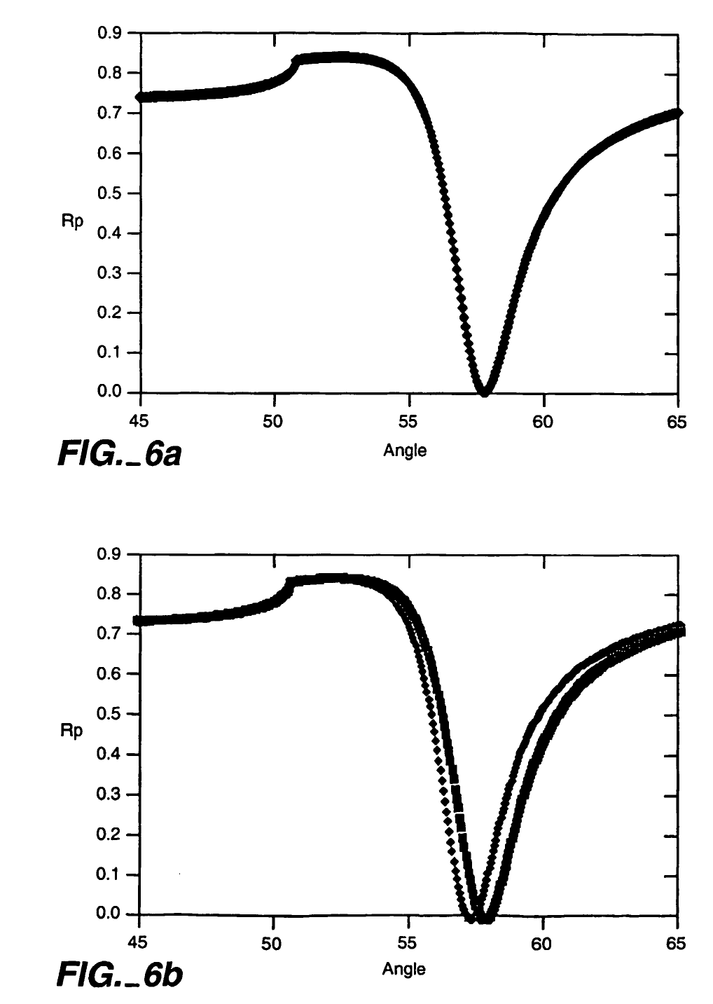

After the reference values are measured and stored to the storage 420, the process 500 moves to a second measuring state 530 wherein the SPR tests are performed again using the same fluid that that will be eventually used during the SPR and SPEF test, such as a buffer, without the compound to be tested. These values are again stored to be used in a determining state 540. In the determining state 540, the individual values of the data points from the second measuring state 530 are divided by their corresponding data points from the first measuring state 520, and the results are recorded as the normalized reflectance or effective reflectance signal. By dividing the fluid to surface measurements with the air to surface measurements, an effective reflectance rather than an actual reflectance is determined resulting in a relatively smooth set of results. By normalizing the data in this way, it is not necessary to measure the incident light to determine a measured reflectance, which may be defined as the reflected light intensity divided by the incident light intensity, thereby eliminating the need for additional components. FIG. 6a illustrates a set of surface to buffer interface SPR data taken over a range of reflection angles that has not been normalized and that is superimposed over a plot of reference data of surface to air readings over the same range of angles. The surface to buffer data points drop dramatically between 56 degrees and 58 degrees as resonance occurs while the reference data points remain relatively constant through this range. However, both sets of data are relatively erratic over the range of data and normalization can be utilized to counteract this effect. As illustrated in FIG. 6b, the normalization of the surface to buffer data can result in a smoother set of data points over the measured range. In FIG. 6b, the set of reference data points appears as a straight line at an effective reflectance value of 1, where the buffer to surface data appears as a smooth curve over the range measured.

However, the incident light may be measured and actual reflectance can be measured if desired, or, in the alternative a reference reflectivity can be measured by subtracting the reference data of the first measuring state 520 from the reflectance data of the second measuring state 530. The process 500 then ends at a terminating state 550. By the process 500 illustrated in FIG. 5, irregularities in the beam of light being used can be accounted for and the SPR results can be substantially repeated regularly for consistent and reliable results.

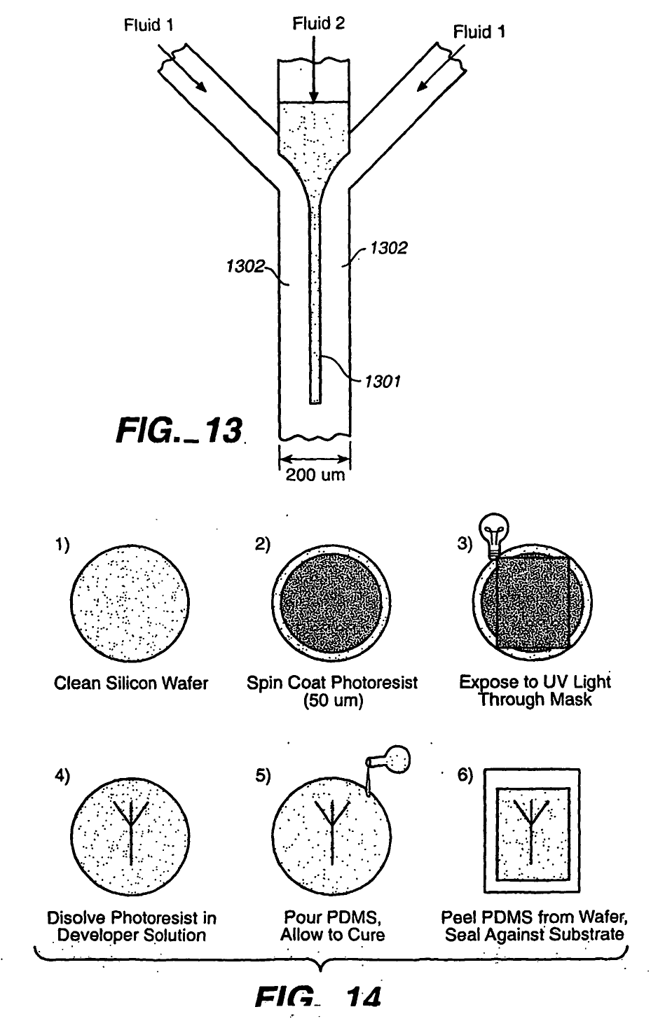

In another embodiment of the invention, a system for quantifying the properties of lateral diffusion and reactivity of adsorbed macromolecules measured by microfluidic patterning of substrate surfaces is disclosed. Specifically, a system is disclosed to perform and capture data from flowing, creating and relaxing surface gradients in at least two interfacing fluid streams, at least one of the streams containing macromolecules, the macromolecules interacting with the surface, wherein the flow has a low Reynolds number so that the at least two fluid streams do not mix. FIG. 13 illustrates one embodiment of such an apparatus. FIG. 13 illustrates a testing system having a testing apparatus similar to that provided above 1300 and can have a computer, as provided above. The testing apparatus 200 is in communication with the computer 400 through a data link 202 to operate and report on the tests being run. The computer 400 sends commands to the test apparatus 200 to control the test sequence and monitor parameters of the test. The test apparatus 200 sends data measurements to the computer 400 for storage and analysis. Observation of the phenomenon can also be made visually.

According to this embodiment of the invention, channel geometry can be established, as shown in FIG. 13, where two fluids are flowed in alternating lanes and gradients are created and relaxed. As can be seen, the fluid in the middle lane 1301 will be directed down the center of the channel with limited mixing with fluid in the outer lanes 1302. Because of the lack of inertial forces and turbulence in the system, the only mechanism for mixing in the microchannel is the relatively slow process of diffusion. Also, because all lanes are flowing in a device such as described herein, molecules that have diffused across lane boundaries are promptly swept downstream by the flow.

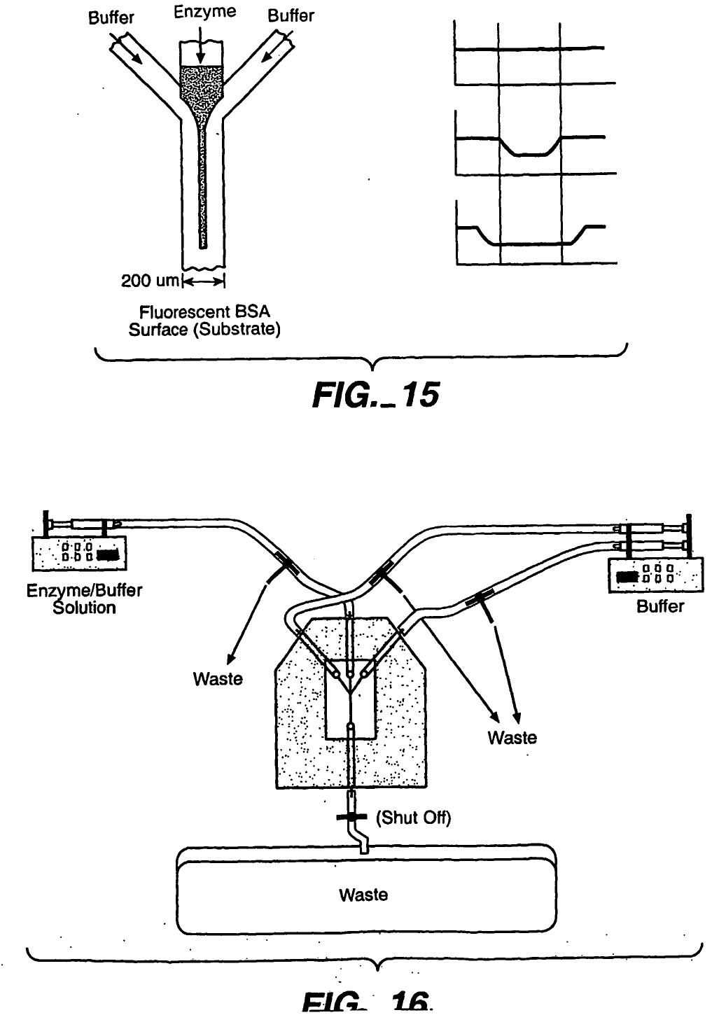

Buffers are flowed down the outside lanes 1302 and enzymes through the middle 1301, forming a stripe of enzyme down the middle of the substrate surface. The boundary between the enzyme lane and the buffers is kept relatively sharp by flowing at a high linear velocity (10-20 cm/s). Referring to FIG. 15, initially the thickness profile of the surface will be flat as no cleavage has yet occurred. Once the enzyme flow begins, a trench will form, as the enzyme will cleave the substrate adjacent to the middle lane. Since the enzyme solution in the bulk is localized to the middle lane, any widening of this trench will be due to surface diffusion of the enzyme as it reacts away the surface bound protein. Measurement of surface diffusion of the enzyme is indirect as the presence of diffusing unlabeled enzyme is shown by loss of labeled substrate. This is an important aspect of the technique because the actual observable is not the enzyme itself and thus although the trench formation can be imaged by methods that are completely label free, such as ellipsometric, brewster angle or surface plasmon imaging. The indirect nature of the technique also permits use of a label (i.e. a labeled substrate). As a result, widening of the region of reduced intensity indicates surface diffusion.

The embodiment measures gradient diffusion, in contrast to self diffusion coefficients measured by earlier TIR-FRAPP experiments. Although the two phenomena of gradient (or mutual) and self diffusion are quite different from one another, as self diffusion is strictly due to thermal energy and gradient diffusion involves the relaxation of concentration fluctuations (or gradients), both can be limited by stronger interactions with the surface. Thus, the effect of an enzyme that is less active due to limited mobility should be seen regardless of whether we measure gradient diffusion or self diffusion.

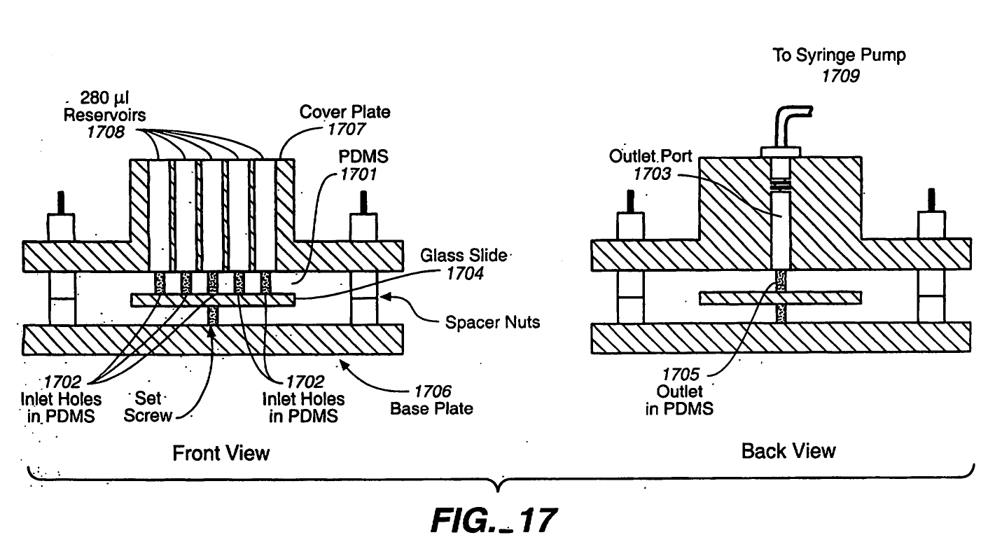

FIG. 17 shows a device of the invention, a microfluidic chip. The chip comprises a PDMS piece 1701 with an embedded channel geometry created by soft lithography techniques; a channel geometry with multiple input channels 1702 combined into a single straight channel; 1 mm diameter circular holes in the PDMS piece at each inlet and outlet 1705 to allow for the delivery of fluids to and from the chip; a glass slide 1703 sealed against the PDMS piece; a flow cell (not shown) composed of multiple inputs and a single output matching those of the PDMS piece; a rectangular cutout (not shown) for placement of the microfluidic chip; an aluminum clamp (not shown) which may fit either over a prism adjacent to the glass slide 1704 or directly onto the glass slide and serves to apply pressure to the chip ensuring a tight seal; a rectangular acrylic cover plate 1707 with holes drilled through the plate that are matched up with the inlets on the chip and serve as fluid reservoirs 1708 for each of the inlets; a polished smooth bottom side of the plate that seals tightly against the PDMS portion of the chip; a siphon system 1709 to keep the reservoirs filled and an acrylic base plate 1706 with comparable dimensions to the cover plate.

The embodiment is of a “pull” configuration, which directly delivers fluids to the chip without any external connectors. The system is not closed, but a closed system of the invention may also be envisioned. A closed system may be more adaptable to imaging systems, as provided above, which require a prism to be coupled to the chip. The siphon only fills the reservoirs containing buffers. The reservoirs containing enzyme solutions are filled by individual syringes attached to a single syringe pump. A glass microscope slide presents the appropriate substrate surface, such as a covalently bound protein layer.

The base plate serves the same purpose as the clamp in a push setup as it tightens down to seal the chip as well as providing a window for observation through a microscope. Solutions comprising enzyme molecules and pure buffer flowed in alternate inlets of the flow cell at low Reynolds number allow for creation of multiple lanes of fluids not interacting with each other but without any physical barrier. Detection is with fluorescence microscopy on an inverted microscope equipped with a Hg light source, red light filter and a CCD camera. The system requires a non-fluorescent protease flowing over a fluorescently labeled substrate surface. Loss of intensity indicates cleavage.

### EXAMPLES

The following examples are used to illustrate certain embodiments of the present invention and are not meant to be limiting.

### Example 1

### Biotin/Avidin/Sandwich Experiment

A schematic of an experimental setup is shown in FIG. 3. In this example, a 35 mW He—Ne laser was directed by a series of mirrors through a neutral density filter (used to control incident light intensity) and into the optical train. The beam passed through a Glan-Thompson polarizer to ensure p-polarized light for the SPR experiment. A spatial filter removed stray light from the beam, yielding a more homogeneous profile, followed by a beam collimator/expander which expanded it to the appropriate diameter (˜2.5 cm.).

The widened beam was focused onto the sample cell by a vertically mounted planar cylindrical lens, as in the scanning angle reflectometry apparatus employed by Leermakers et al. Leermakers, F. A. M.; Gast, A. P., Macromolecules, 1990, 24(3), 718-730. An entire SPR spectrum can thus be captured at once on the CCD. A horizontal spectrum over an angular width of ˜8° was captured. This differs from the approach used by Lieberman et al. (Liebermann, T.; Knoll, W., Colloids Surf A, Physicochem. Eng. Aspects 2000, 171(1-3), 115-130).

The reflected beam was “vertically averaged” by a horizontally mounted cylindrical lens and directed onto the CCD element of a 1D CCD, which recorded the reflectivity data. Fluorescence was measured from behind the sample cell. A 5× microscope objective lens collected light emitted from the center of the sample cell and a PMT recorded a photon count. Both the PMT and camera were connected directly to a PC computer and data was recorded using Labview software.

A diagram of the sample cell 300 is also shown in FIG. 3. In this example, a thin is 50 nm gold film with a 2 nm chromium undercoat was evaporated onto a polished SF10 glass (n=1.723) slide (Schott Glass Technologies). The surface was functionalized by means of a thiol anchor carrying the selected reactive group. Another glass slide was sandwiched together with the first, with the gap between them defined by a silicone gasket (thickness 0.5 mm). A solution containing the analyte was then flowed through the cell by means of a peristaltic pump.

The entire assembly was mounted onto an SF10 glass (n=1.723) hemi-cylindrical prism. Index matching is accomplished via a Series M index matching liquid (n=1.730) from Cargille Laboratories. This provided a close but not perfect match to the SF10 glass and as a result, an interference pattern was observed on the CCD image. The effects of this pattern were eliminated by vertically averaging the image using a second focusing lens 250 (FIG. 2) just in front of the camera.

Self assembled monolayers of propionic acid were prepared by dipping the gold-coated slides into a 3-mercaptopropionic acid solution (200 μL/100 mL) for 30 min. The carboxyl end groups of the immobilized hydrocarbon chains were activated for peptide bond formation using EDC (1-ethyl-3-(3-dimethylaminopropyl)-carbodiimide hydrochloride)/NHS(N-hydroxysuccinimide) chemistry. Slides were immersed in a solution of 40 mg/100 mL EDC and 60 mg/100 mL NHS in reaction buffer (2-(N-morpholino)ethanesulfonic acid 20.62 g/L, NaCl 29.2 g/L) for 1 hr. The EDC/NHS step produced a water stable ester able to react with primary amines. Biotinylated surfaces were produced by reaction with biocytin hydrazide (Molecular Probes B-1603, 10 mg/100 mL for 2 hours) in reaction buffer. Monolayers of covalently bound fluorescently tagged bovine serum albumin (BSA) were formed by reaction with Texas Red/BSA conjugates (Molecular Probes—A23017, 2.5 mg/mL for 2 hours) in reaction buffer. In either case, the slides remained overnight in protein or biocytin hydrazide solution to ensure complete reaction.

Avidin-Texas Red conjugates (A-820) were purchased from Molecular Probes. Biotin in solution was conjugated to BSA in a manner identical to that used to biotinylate the surface. Carboxy-side chains of BSA (10 mg/100 mL) were activated by reaction with EDC (400 mg/100 mL) and NHS (600 mg/100 mL) for one hour and then covalently linked to the amine group in biocytin hydrazide (5 mg/100 mL). Conjugates were separated from unreacted biotin using gel filtration chromatography. The protein used was B. lentus subtilisin enzyme. All proteins were assumed to have a refractive index of n=1.57. Jung, L. S. et al. Langmuir 1998, 14 (19), 5636-5648.

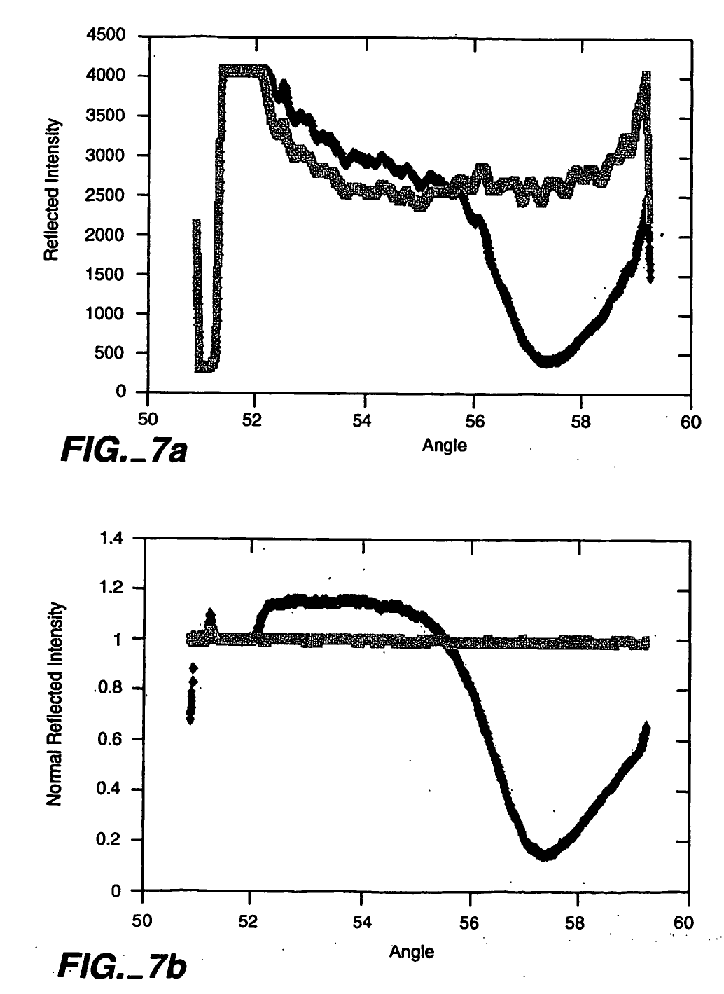

A typical “raw” reflectivity plot is shown in FIG. 7a. The gold/buffer reflectivity curve was normalized on the gold/air signal at the same angular range. This image processing step allowed the effects of inhomogeneities in the beam profile caused either by the laser or the surface to be removed. Normalized curves are shown in FIG. 7b.

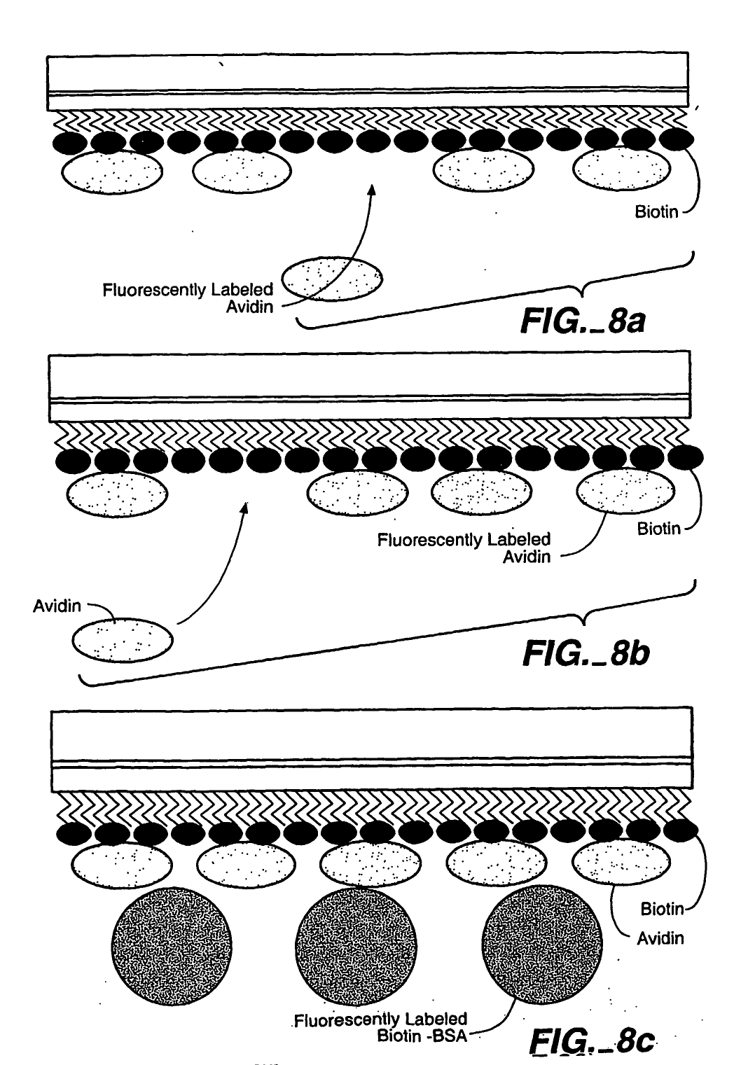

As illustrated in FIG. 8, this experiment included binding a monolayer of biotin to a functionalized layer of hydrocarbons. The monolayer of fluorescently labeled avidin was allowed to bind the biotin (FIG. 8a). Based on the Liebermann et al. (Colloids Surf A, Physicochem. Eng. Aspects 2000, 171(1-3), 115-130) results, the SPR and SPEF signals were proportional to one another. The use of a planar cylindrical lens to focus a fan of laser light onto the surface further simplified this analysis. In a conventional single angle kinetics experiment, the amount of energy transfer to the surface plasmon wave changed through the course of the experiment. This detracted from the linearity of the correlation between the SPR and SPEF signals. Liebermann et al., supra, discussed this effect and stated that it must be accounted for during the analysis. However, in the present experiments, light was impinging on the surface at a range of angles and thus the intensity transfers to the surface plasmon wave remained constant throughout the experiment. Thus, no further signal processing was necessary to linearly correlate the SPR and SPEF measurements.

In the next step, labeled and unlabeled avidin were successively added to the monolayer of biotin (FIG. 8b). The SPR signal rose throughout both additions due to a continued increase in protein layer thickness; however the SPEF signal only rose following addition of the labeled protein. Thus, the two signals were used to simultaneously measure binding of the labeled and unlabeled species.

The same idea was used to distinguish the presence of two separate proteins on the surface in the second part of a “sandwich” experiment (FIG. 8c). The first layer consisted of unlabeled avidin and thus no rise in SPEF signal was observed. A fluorescently labeled biotin-BSA conjugate was then added to this layer. The rise in SPEF signal indicated the formation of the second layer. Once again, the amounts of the two proteins on the surface were differentiated by use of the SPR and SPEF signals in tandem.

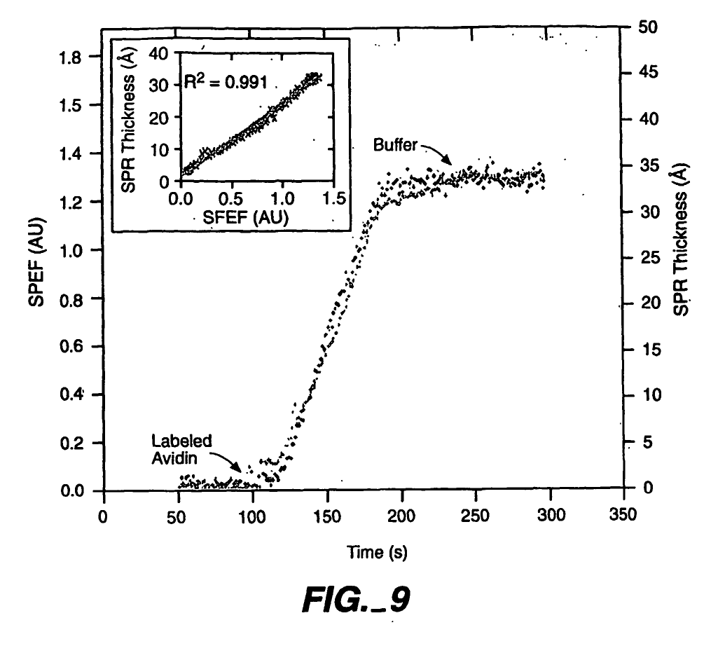

The results from these three experiments are shown in FIGS. 9-11. In FIG. 9, fluorescently labeled avidin was flowed over a biotin monolayer and bound forming a 31±3 Å thick layer. SPR and SPEF signals were essentially identical. The inset clearly shows the linearity of the signals. Another advantage of the tandem experiment is that it discounts the need for an independent calibration of the fluorescence signal. The two signals can be calibrated with one another and an average layer thickness determined.

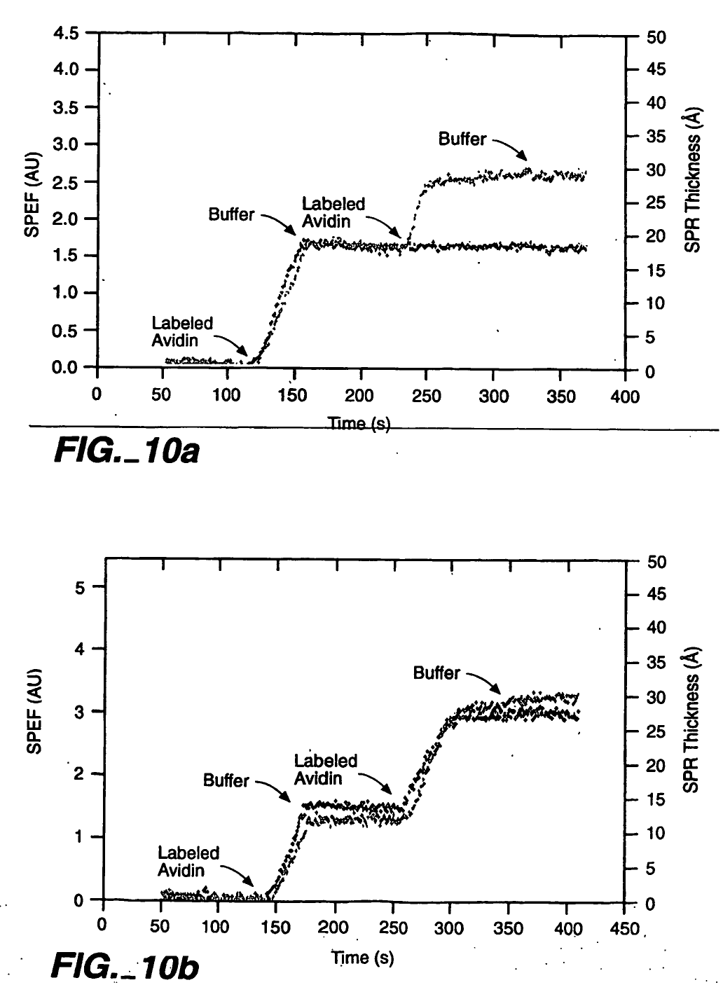

An example of an incomplete monolayer is shown in FIG. 10. Labeled avidin was allowed to bind to a thickness of ˜18 Å. Unlabeled avidin was then added and allowed to complete the monolayer (FIG. 10a). This second step illustrates the separation of the two components, as the SPR signal rose but the SPEF signal remained unchanged. The corresponding control experiment is shown in FIG. 10b. In this case, labeled avidin was added in both steps demonstrating no distinction between SPR and SPEF signals.

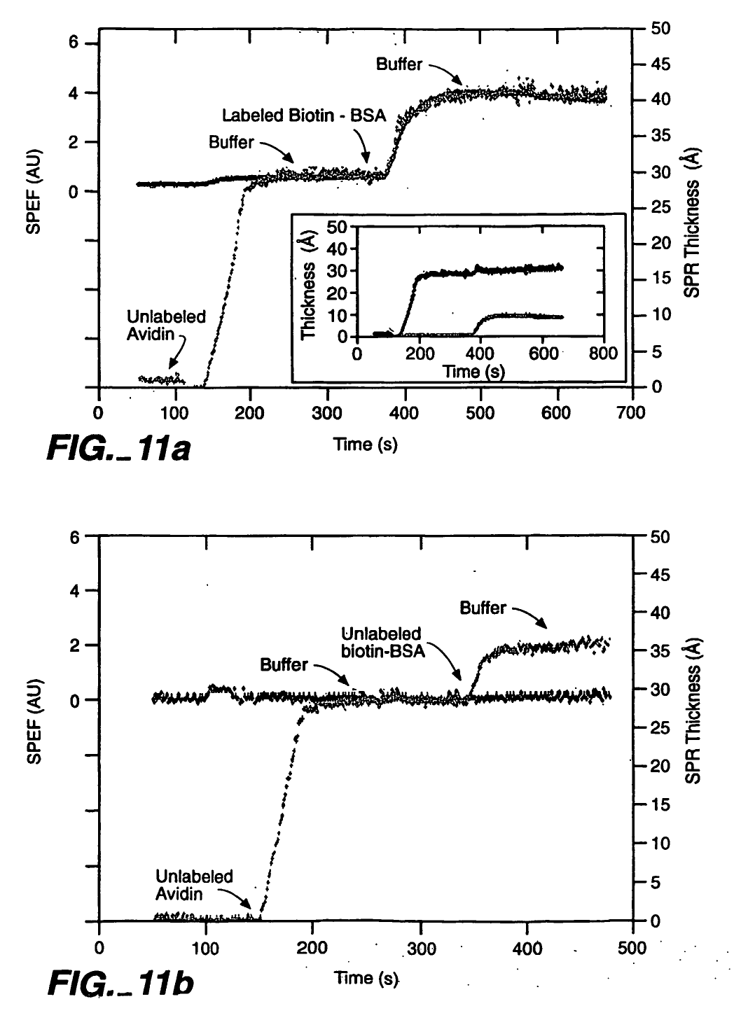

Finally in FIG. 11, the same idea was applied to the distinction of two unrelated proteins. Fluorescently labeled BSA was passed over an unlabeled avidin layer and bound to a thickness of ˜10 Å (FIG. 11a). A fluorescence signal was only detected in the BSA step and thus the amounts of the two proteins on the surface at any given time were determined as shown in the inset. In the corresponding control (FIG. 11b), unlabeled BSA was added and no fluorescence signal was detected in either step.

### Example 2

### Measurement of Enzyme Kinetics

Enzymes

A goal of the present experiment in developing this technique was to simultaneously measure the adsorption and reaction kinetics of an enzyme interacting with a substrate surface. The model substrate for this experiment was fluorescently labeled BSA. The enzyme was the serine protease subtilisin. Subtilisin adsorbs to and cleaves BSA from the surface.

For this study, variants of Bacillus lentus subtilisin (BLS) were used. This enzyme differs from the commercially available Subtilisin BPN′ (BPN) at 103 of 269 residues. Kuhn et al., Biochemistry 1998, 37, 13446-13452. BLS (MW=27 kD) is a serine protease with the characteristic Ser(221), His(64), Asp(32) catalytic triad in its active site. The reference enzyme for the experiment, which was labeled BLSv1, contained three additional mutations to the BLS structure: N76D (substitute asparagine 76 with aspartic acid), S103A (substitute serine 103 with alanine), and V1041 (substitute valine 104 with isoleucine). The effects of surface charge variations were investigated by studying enzymes with additional single charge mutations on the surface of BLSv1.

The five variants were thus labeled: BLSv1 (the reference enzyme), BLSv1-Q109R (substitute neutral glutamine 109 with positively charged arginine), BLSv1-G159D (substitute neutral glycine 159 with negatively charged aspartic acid), BLSv1-Q206R (substitute neutral glutamine 206 with positively charged arginine) and BLSv1-Q206E (substitute neutral glutamine 206 with negatively charged glutamic acid). BLSv1-Q109R and BLSv1-Q206R are referred to as positive mutants, and BLSv1-G159D and BLSv1-Q206E as negative mutants. In each case, the mutation is far from the active site.

Coulombic and Poisson Boltzmann surface charge calculations show that BLS is a polar molecule, in which the “front” surface (containing the active site) is neutral to negatively charged and the “back” side has a more positive character. The four mutants of the reference enzyme are “front side” mutants. All enzymes were provided by Genencor International (Palo Alto, Calif.). The enzyme stock solutions were used as received.

Buffer Solutions

High ionic strength buffer (2 mM sodium carbonate+˜15 mM sodium sulfate, conductivity=3.2 mS/cm) and low ionic strength buffer (2 mM sodium carbonate) were used for the enzyme reaction experiments. Experiments were run at pH 10, the optimum pH for BLS activity.

Substrate Surfaces

Immobilized substrate surfaces were prepared on glass slides (Schott Glass Technologies; SFIO glass material; dimension 1 in.×1 in.×1 mm). A thin chromium (2 nm) undercoat followed by a 50 nm gold film were deposited on the glass slides by thermal evaporation using an Edward Auto 302 vacuum coater. The gold-coated slide glasses were dipped in 3-mercaptopropionic acid solution (200 μL/100 mL) for 30 min. This thiol coating produces a self assembled monolayer with acidic surface groups. The slides were then immersed in a solution composed of 1-ethyl-3-(3-dimethylaminopropyl)-carbodiimide hydrochloride (40 mg/100 mL) and N-hydroxysuccinimide (60 mg/100 mL) in a reaction buffer (2-(N-morpholino)ethanesulfonic acid 20.62 g/L, NaCl 29.2 g/L) for 1 hr to activate the surface for attachment of the protein substrate. A 2.5 mg/mL solution of Texas Red tagged bovine serum albumin (Molecular Probes) in the reaction buffer was added via a transfer pipet directly onto the gold surface and the surface linking reaction allowed to proceed for two hours, creating a surface bound layer of BSA. Prior to each experiment, the substrate surfaces were rinsed with Milli-Q water and then dried by a gentle air stream. After the experiment, the gold films were removed by acid (70% hydrochloric acid+30% nitric acid), and a new gold layer was re-deposited for further experiments.

Enzyme Inhibition

Subtilisin is inhibited by addition of phenylmethylsulfonyl fluoride (PMSF). A 100 mM solution in ethanol was diluted to 2 mM in MES buffer, pH 5.5, and added to subtilisin stock solution (1 mg/mL) at 20 vol % and then incubated at room temperature for 30 min.

SPR-SPEF Measurement

Details of the SPR/SPEF apparatus are described herein. A diagram of the sample cell is shown in FIG. 3. In this example, the flow channel was made of two glass slides with a silicone gasket insert (0.5 mm thickness). Buffer and enzyme solution were flowed at wall shear rates of 400 s⁻¹. Bulk enzyme concentrations were 2 μg/mL. Angular SPR profiles and fluorescence light intensities were measured simultaneously. The total protein (BSA+enzyme) layer thickness was obtained from the angular SPR profile using a Fresnel calculation. The amount of fluorescently labeled BSA was obtained from the fluorescence signal intensity. The linearity of the two signals allows one to determine the amount of adsorbed enzyme from their difference, as described herein.

Strength of Association—PMSF Inhibited Enzyme Experiment

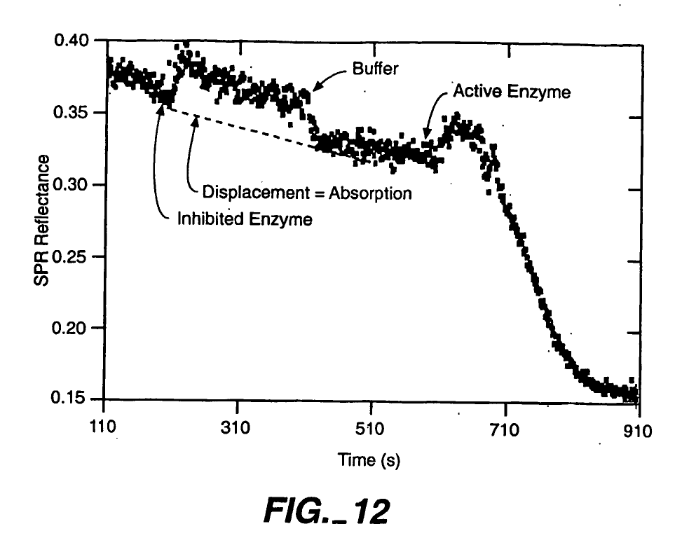

In the next experiment, the association between the enzyme and the surface was examined further by comparing the adsorption properties of the five variants using a PMSF inhibited enzyme experiment. PMSF (phenylmethylsulfonyl fluoride) reacts with the serine in the catalytic triad and renders the enzyme 90% inactive. The nearly inactive enzyme was useful for studying adsorption onto an intact BSA monolayer, as substrate hydrolysis was severely limited. Sample SPR results are shown in FIG. 12. Initially, buffer was passed over the surface to establish a surface plasmon. Following introduction of inhibited enzyme, the total surface layer thickened, as shown by the rise in SPR signal. The displacement in the signal was indicative of the amount of adsorbed enzyme. Once a steady level of adsorption was reached, the enzyme solution was replaced by buffer. Active enzyme was subsequently passed over the surface to verify the presence of BSA through its loss to hydrolysis.

Reactivity

The reactivity was analyzed using time-course SPEF data. The fluorescence signal was calibrated using the initial high fluorescence as a reference point with 100% substrate. It was also noted that following completion of the reaction, the surface was free of substrate (this was confirmed by examining the location of the minimum of the SPR spectrum). The endpoint, therefore, corresponded to 0% substrate. This time-course data was converted to a more intuitive velocity vs. substrate concentration curve. The instantaneous rates of change were obtained by taking slopes along the curve, with each point corresponding to a reaction velocity. A sample reaction velocity vs. substrate curve was generated in this way. The early time (high substrate concentration) data was removed from the curve so as not to include artifacts resulting from the ten second fill time of our sample cell in the analysis.

In Situ Adsorption

The SPEF data alone provided information on reactivity, as shown in the previous section. It was combined with SPR data to track enzyme adsorption as it hydrolyzed the BSA layer. A plot of enzyme adsorption as a function of substrate concentration is obtained by simply matching the beginning and end SPEF and SPR signals and then taking a difference signal. Since SPR measured total protein (enzyme+BSA) layer thickness and the SPEF isolated BSA, their difference was the amount of enzyme adsorbed on the surface. The curve is divided into high and low substrate concentration regions. The beginning of the low concentration regime was delineated as the point where enzyme adsorption has reached a plateau and adsorption kinetics were no longer limiting. In this study, attention was focused on the low concentration (0-25% substrate) region, the same conditions that were studied in the solution assays.

### Example 3

### A Microfluidic Chip for Measuring Diffusion and Reactivity

A microfluidic chip was created for quantifying the properties of lateral diffusion and reactivity of adsorbed macromolecules measured by microfludic patterning of substrate surfaces, as shown in FIG. 17. The chip comprises a PDMS define piece (25 mm×75 mm×˜3 mm thickness) with an embedded channel geometry created by soft lithography techniques; a channel geometry with multiple input channels combined into a single straight channel; a channel geometry with 100-200 μm channel widths and 50 μm channel thicknesses; 1 mm diameter circular holes in the PDMS piece at each inlet and outlet to allow for the delivery of fluids to and from the chip; a glass slide of dimensions 25 mm×75 mm×1 mm sealed against the PDMS piece; a flow cell composed of multiple inputs and a single output matching those of the PDMS piece; a rectangular cutout of dimensions (25 mm×75 mm×4 mm) for placement of the microfluidic chip; an aluminum clamp which may fit either over a prism adjacent to the glass slide or directly onto the glass slide and serves to apply pressure to the chip, ensuring a tight seal; a rectangular acrylic cover plate (with a base of dimension 2.75″×1.25″ and a thickness of 1.25″) with holes drilled through the plate that are matched up with the inlets on the chip and serve as fluid reservoirs for each of the inlets; a polished smooth bottom side of the plate that seals tightly against the PDMS portion of the chip; a siphon system to keep the reservoirs filled; an acrylic base plate with comparable dimensions to the cover plate and a thickness of no more than 0.2″.

### Example 4

### Creation of an Assay to Measure Surface Diffusion-Three and Five Lane Substrate Surfaces

Surfaces are prepared following the methods described by Gaspers et al. (16). Cleaned glass microscope slides (25 mm×37.5 nm×1 mm) are soaked in acetone for 10 minutes and then placed in a 0.1% v/v solution of 3-amino-propyltriethoxysilane (ATES) in acetone, and incubated at 37° C. for 30 minutes. Carboxy-side chains of Texas Red/BSA conjugates (Molecular Probes—A23017, 0.5 mg/mL) were activated by reaction with EDC (20 mg/5 ml) and NHS (30 mg/5 ml) in cross linking buffer for one hour. The slides were then brought into contact with 1 mL of the activated Texas Red/BSA solution for 48 hours at room temperature. The wetting properties of the amine-terminated surface ensured complete coverage of the slide by the protein solution. BSA coated slides were stored in carbonate buffer at 4° C.

Creation of Buffers

Carbonate buffers are as described previously. PBS buffer was prepared at pH 7.4 ([phosphate]=10 mM; [NaCl]=150 mM). Enzymes described as wildtype (WT) are BLSv1 (as stated previously). The GG36 enzyme is Subtilisin BLS (34). All other enzymes are single amino acid substitutions of BLS.

Flow Schemes

Three and five inlets were used in a microfluidic chip. In all experiments, flow was pressure driven. Positive pressure to the system to “push” the fluids through the chip was initially chosen. The flow scheme is shown in FIG. 16. The five lane experiments were all conducted using negative pressure, or in the “pull” configuration, shown diagrammatically in FIG. 17. In this case, no connections are necessary as the chip is filled directly from reservoirs and pulled from a single outlet. The buffer reservoirs were kept filled using a siphon and the enzyme reservoirs were pumped full from a syringe pump.

Three Lane Experiment

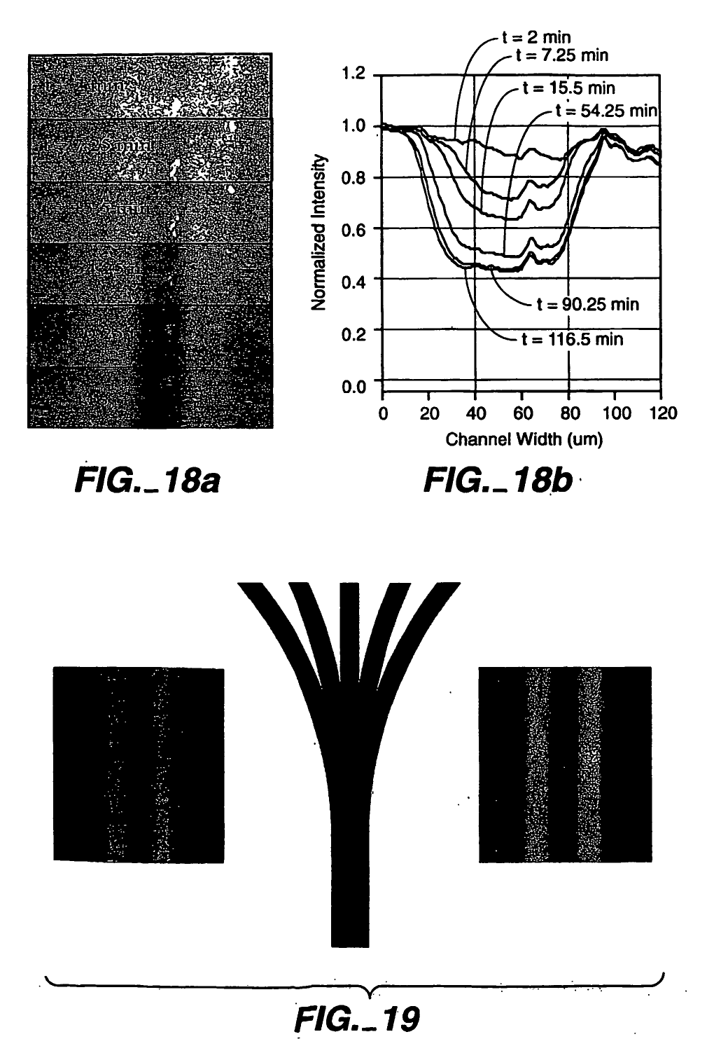

The results of a three lane experiment with enzyme flowed down the middle lane are shown in FIG. 18. The beginnings of trench formation are first seen after about 2 minutes. As the intensity in the middle region drops at later time points, the trench deepens with the passage of time. Interestingly, the trench also widens. FIG. 18b, shows the intensity profiles across the channel. The shaded area indicates the original enzyme lane width. It is clear that after almost two hours of enzyme flow, the trench has widened considerably beyond the original lane. This is a clear indication that the enzyme is diffusing along the surface as it cleaves the substrate.

Five Lane Experiment

Five lane experiments more readily show reaction and diffusion characteristics of two variants simultaneously. In the five lane experiments, different enzyme variants were flowed in lanes 2 and 4. In control experiments however, as shown in FIG. 19, because of sharp turns at the inlets, secondary flows led to a small degree of mixing and what appeared to be a “flaring out” of the lanes. In order to keep the lanes sharp, the structure of the junction was altered as shown in FIG. 19b. The inlet streams were now “guided” into the main channel by the more smoothed curved lines. As seen in FIG. 19c, a marked improvement was achieved in the sharpness of the lanes and the “flaring” effect in the lanes was effectively eliminated.

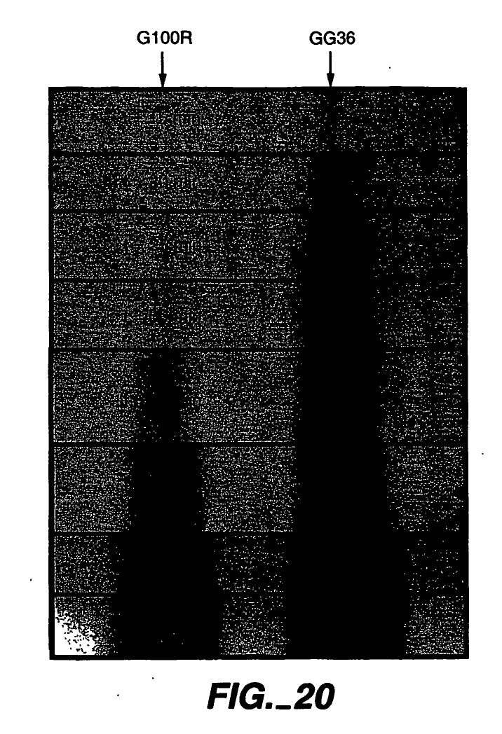

Enzymes were then run through the lanes, as shown in FIG. 20. In this case, the enzymes used were GG36, the wildtype subtilsin for this experiment, and the G100R mutant. The experiment was run using low ionic strength buffer and it is clear that the wildtype is more reactive and faster diffusing than the G100R mutant. This corresponds well with previous adsorption data, because in cases where the enzyme is very strongly adsorbed to the surface, the reaction rate is reduced.

### CONCLUSION

Thus, those of skill in the art will appreciate that new devices and methods used for quantifying the properties of molecules, and specifically, measuring the diffusion and rate of reactions, are disclosed that employ the simultaneous use of SPR and SPEF and microfludics.

One skilled in the art will appreciate that these methods are and may be adapted to carry out the objects and obtain the ends and advantages mentioned, as well as those inherent therein. The devices, methods, and procedures described herein are presently representative of preferred embodiments and are exemplary and are not intended as limitations on the scope of the invention. Changes therein and other uses will occur to those skilled in the art which are encompassed within the spirit of the invention and are defined by the scope of the claims.

It will be apparent to one skilled in the art that varying substitutions and modifications may be made to the invention disclosed herein without departing from the scope and spirit of the invention.

Those skilled in the art recognize that the aspects and embodiments of the invention set forth herein may be practiced separate from each other or in conjunction with each other. Therefore, combinations of separate embodiments are within the scope of the invention as claimed herein.

All patents and publications mentioned in the specification are indicative of the levels of those skilled in the art to which the invention pertains. All patents and publications are herein incorporated by reference to the same extent as if each individual publication was specifically and individually indicated to be incorporated by reference.

The invention illustratively described herein suitably may be practiced in the absence of any element or elements, limitation or limitations which is not specifically disclosed herein. Thus, for example, in each instance herein any of the terms “comprising”, “consisting essentially of” and “consisting of” may be replaced with either of the other two terms. The terms and expressions which have been employed are used as terms of description and not of limitation, and there is no intention that in the use of such terms and expressions indicates the exclusion of equivalents of the features shown and described or portions thereof. It is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

Other embodiments are within the following claims.

1. A device for quantifying the properties of molecules by measuring surface plasmon resonance and fluorescence of a sample, comprising:
a light source capable of directing a beam of light at a sample cell, wherein said sample cell comprises a first compound bound to a metallic surface;
a first detector for measuring the surface plasmon resonance from said sample cell;
a second detector for measuring the fluorescence intensity from said sample cell; and
a module for calculating the catalytic activity of said enzyme from said surface plasmon resonance measurement and said fluorescence intensity measurement.

2. The device of claim 1, wherein said metallic surface comprises gold.

3. The device of claim 1, wherein said first compound is bound to SAMS (self-assembled monolayers) on said metallic surface.

4. The device of claim 1, wherein said sample cell comprises a prism.

5. A system for quantifying the properties of molecules by determining the rate of catalytic activity of an enzyme; comprising:
a light source capable of directing a beam of light at a sample cell, wherein said sample cell comprises a fluorescent compound bound to a metallic surface;
a first detector for taking a surface plasmon resonance measurement of said sample cell as an enzyme is contacted with said compound;
a second detector for taking a fluorescence intensity measurement of said compound as said enzyme is contacted with said compound; and
a module for calculating the catalytic activity of said enzyme from said surface plasmon resonance measurement and said fluorescence intensity measurement.

6. The system of claim 5, wherein said metallic surface comprises gold.

7. The system of claim 5, wherein said first compound is bound to self-assembled monolayers on said metallic surface.

8. The system of claim 5, wherein said first detector is a reflectance detector, which detects light reflected from said sample cell.

9. The system of claim 8, wherein said first detector is a CCD detector.

10. The system of claim 8, wherein the angle said reflected light makes with the normal of said sample cell is substantially equal to the angle said beam of light from said light source makes with the normal of said sample cell.

11. The system of claim 10, wherein the sum of said angle said reflected light makes with the normal of said sample cell and said angle said beam of light from said light source makes with the normal of said sample cell is less than 180°.

12. The system of claim 10, wherein said first detector detects any variations in said angle said reflected light makes with the normal of said sample cell.

13. The system of claim 5, wherein said second detector is a fluorescence detector, which detects fluorescence from said sample cell.

14. The system of claim 5, wherein said second detector is located on the opposite side of said sample cell as said light source.

15. The system of claim 5, wherein said compound fluoresces after being illuminated by said light.

16. The system of claim 5, wherein said enzyme fluoresces after being illuminated by said light.

17. The system of claim 5, wherein said light is monochromatic.

18. The system of claim 5, wherein said light source is a laser light source.

19. The system of claim 5, wherein said module comprises a microprocessor.

20. The system of claim 5, wherein said module comprises a memory.

21. The system of claim 5, wherein said module comprises a computer implemented instructions.

22. A method for measuring diffusion and reactivity comprising
a) flowing at least two interfacing fluid streams, at least one stream containing macromolecules, the macromolecules interacting with the surface, wherein the flow has a low Reynolds number so that the at least two fluid streams do not mix;
b) creating and relaxing surface gradients from step (a); and
c) detecting diffusion and reactivity.

23. The method according to claim 22, wherein the at least two fluid streams comprises three fluid streams.

24. The method according to claim 22, wherein the at least two fluids streams comprises five fluid streams.

25. The method according to claim 22, wherein the detecting step includes at least one of fluorescence microscopy, plasmon imaging, ellipsometric imaging, brewster angle microscopy or total internal reflection microscopy.

26. The method according to claim 22, wherein the surface comprises plastics, polymers, SAMS, lipid bilayers, glass, transparent materials, reflective materials, gold, biomaterials or biodegradable materials or a combination thereof.
